(19) United States
(12) Patent Application Publication
(10) Pub. No.: US 2011/0191288 A1
(43) Pub. Date: Aug. 4, 2011

(54) Systems and Methods for Generation of Content Alternatives for Content Management Systems Using Globally Aggregated Data and Metadata

(76) Inventor: Joseph L. Spears, Hayward, CA (US)

(21) Appl. No.: 12/697,021

(22) Filed: Jan. 29, 2010

(51) Int. Cl. G06F 17/30; G06F 21/24

(52) U.S. Cl. 707/609; 707/E17.005; 726/1

(57) ABSTRACT

Computer-implemented systems and methods are provided that include receiving data or metadata for first content or data or metadata related to the first content. A first alternative for the first content is generated, where the first alternative is based upon data or metadata for the first content or data or metadata related to the first content, and first aggregated content or content-related data or metadata associated with multiple content providers. A selection of the first alternative is received, where the selection of the first alternative generates first additional data or metadata for the first content or first additional data or metadata for content related to the first content.

### TECHNICAL FIELD

The present disclosure relates generally to computer-implemented systems and methods for dynamic management of content and content-related data and metadata.

### BACKGROUND

Content creators (e.g., filmmakers, television producers, recording artists, online game developers, etc.) are significantly limited in their ability to develop and execute content-related strategies such as processing, marketing, promotion, management, packaging, merchandising, fulfillment, delivery, distribution, licensing, and enforcement of their own content and content-related data. Effective mastering and implementation of such efforts is typically beyond the capabilities of content creators because such efforts typically require marketing and/or distribution resources that are unavailable to the content creators. Because of this limitation, content creators often seek to enter into content-related agreements in which the content creators relinquish control with respect to some or all rights in the content (e.g., a licensing agreement with a film distributor granting various territory and/or media rights).

One drawback with traditional content-related agreements (e.g., in the entertainment industry) is that they are rarely available to a content creator (e.g., an independent filmmaker, television producer, or game developer). In other words, often only the most well-known content creators are able to secure a content-related agreement (e.g., a distribution agreement, assignment, or license) with a third party content provider (e.g., a distributor, subdistributor, network, broadcaster, syndicator, publisher, assignee, or licensee). Moreover, even when a content creator is able to secure a content-related agreement, the terms are often very one-sided favoring the content provider. Thus, these content-related agreements are often unfairly restrictive to the content creator, limiting additional marketing or distribution of content for a set amount of time (e.g., until costs advanced or expended pursuant to the agreement are recouped).

Additionally, often such agreements (i) do not contain any provisions that impose a duty on the content provider to actively market or promote the content creator's content, and/or (ii) the content creator does not have sufficient leverage over the content provider to enforce a provision requiring active marketing or promotion of the content. As a result, these agreements can be highly disadvantageous to a content creator for many reasons. For example, over the term of such an agreement, the value of the content is often diminished while the content creator awaits the expiration of the agreement. Moreover, any failure of the content provider to actively market or promote the content can postpone or preclude any potential revenue that may be derived from the content. This can prolong the time it takes for the content creator to recoup the costs associated with creating the content, and in some instances, preclude such recoupment altogether. This can create a cash flow burden on the content creator. Additionally, the terms of such agreements rarely require the content distributor, subdistributor, assignee, or licensee to keep the content creator informed of the success or progress of any content-related strategies.

Thus, what is needed in the art are systems and methods for empowering content creators to market and distribute their own content without entering into onerous one-sided agreements with content providers, such as distributors, subdistributors, assignees, or licensees.

### SUMMARY

The present disclosure addresses the need in the art. Systems and methods are provided for empowering content creators (e.g., initial copyright owners; “authors,” as defined under U.S. copyright law; and those acquiring ownership of media content, such as assignees) to market and distribute their own content without entering into onerous one-sided agreements with content distributors. Additionally, systems and methods are provided for empowering content providers (e.g., third party distributors, subdistributors, broadcasters, networks, syndicators, assignees, and licensees) to market and distribute (including, without limitation, subdistribution, broadcasting, syndication, assignment, and licensing of) content when the content provider is unable to exploit the content through other distribution channels.

In accordance with the teachings provided herein, systems and methods for content and content-related data and metadata processing, marketing, promotion, management, packaging, merchandising, fulfillment, delivery, distribution, licensing, and enforcement are provided. For example, a system and method can be configured to receive data and metadata corresponding to content. A first alternative for the content may be generated, where the first alternative is based on the data and metadata of the content as well as the aggregated content or content-related data for metadata for related content from multiple different content providers. Furthermore, additional content-related data and metadata can be generated from the selection of the first alternative. The additional data or metadata can be used to generate aggregated content or content-related data. Multiple distinct content providers can then be informed that the aggregated content and content-related data and metadata has been generated.

Systems or methods may further be configured to use the aggregated data and metadata, generated statistics and generated data and metadata in combination with existing content-related data and metadata to generate one or more reports and display the one or more reports to multiple content providers. Reports to the content providers may further include data related to the content associated with the content provider as well as aspects of the content associated with another content provider but related to the content.

Systems or methods may further be configured where a second alternative corresponding to the content may be dynamically generated, where the second alternative is based upon the generated additional metadata.

Systems or methods may further be configured to dynamically generate a second alternative and may further include informing a content provider that the first alternative has been selected, receiving instructions to construct a second alternative in real-time, constructing the second alternative in real-time, and displaying the second alternative. Systems or methods may also compare the generated statistics to a predetermined threshold.

Systems or methods may also be configured so that the data and metadata corresponding to the content may include one or more content attributes, where each attribute is individually weighted. The first alternative and the second alternative may be activated and deactivated independent of one another.

As another example, computer-implemented systems and methods may include receiving data or metadata for first content or data or metadata related to the first content. A first alternative for the first content may be generated, where the first alternative is based upon data or metadata for the first content or data or metadata related to the first content, and first aggregated content or content-related data or metadata associated with multiple content providers. A selection of the first alternative may be received, where the selection of the first alternative generates first additional data or metadata for the first content or first additional data or metadata for content related to the first content.

Particular embodiments of the subject matter described in this specification can be implemented to realize one or more of the following advantages. A content creator is able to develop and execute one or more content-related strategies (e.g., processing, marketing, promotion, management, packaging, merchandising, fulfillment, delivery, distribution, licensing, and enforcement) for content owned by, or licensed to, them at a cost that is not prohibitive and for a flexible duration. Additionally, a content creator is provided data (e.g., one or more data elements) for use in developing and executing content strategies that best suit the content. Data is also provided to the content creator for measuring the success or failure of a content strategy. Using the data, a content creator can monitor and dynamically adjust a content strategy. A content creator can use content-related data to efficiently identify and reach specific (e.g., targeted) audiences. A content creator can also collaborate with one or more audience members (e.g., to expand content awareness). Additionally, content creators can collaborate with one or more other content providers (e.g., to develop content-related strategies corresponding to the content of one or more collaborating content creators). Further, a content provider is empowered to market and distribute a content creator's content in instances where such third party distributors or licensees do not otherwise have access to certain distribution or marketing channels/verticals, exploitation outlets, or geographic territories due to a lack of industry clout and/or connections, available funds, staffing, etc.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 shows a block diagram of an example system for content and content-related data and metadata processing, marketing, promotion, management, packaging, merchandising, fulfillment, delivery, distribution, licensing, and enforcement.

FIG. 2 shows an exemplary display of certain components within a content management system.

FIG. 3 shows an exemplary display of additional components within a content management system.

FIG. 4 shows an exemplary interface for use by a content creator.

FIG. 5 shows an exemplary interface for a catalog control.

FIG. 6 shows an exemplary interface for adding or editing content using a control within the catalog manager.

FIG. 7 shows another example of an interface for adding or editing content using a control within the catalog manager.

FIG. 8 shows another example of an interface for adding or editing content using a control within the catalog manager.

FIG. 9 shows another example of an interface for adding or editing content using a control within the catalog manager.

FIG. 10 shows another example of an interface for adding or editing content using a control within the catalog manager.

FIG. 11 shows another example of an interface for adding or editing content using a control within the catalog manager.

FIG. 12 shows another example of an interface for adding or editing content using a control within the catalog manager.

FIG. 13 shows an exemplary interface for creating offers using a control within the catalog manager.

FIG. 14 shows an example of an interface for use when interacting with one or more licensing packages.

FIG. 15 shows an example of an interface for creating an offer.

FIG. 16 shows an example of an interface for use when interacting with one or more licensing packages.

FIG. 17 shows another example of an interface for creating an offer.

FIG. 18 shows an exemplary up-sell interface for creating an up-sell option using a control within the catalog manager.

FIG. 19 shows an exemplary interface for use when interacting with one or more up-sell licensing packages.

FIG. 20 shows an exemplary cross-sell interface for creating a cross-sell option using a control within the catalog manager.

FIG. 21 shows an example of an interface for use when interacting with one or more cross-sell licensing packages.

FIG. 22 shows an example of an indirect interface for creating an insider offer using a control within the catalog manager.

FIG. 23 shows an example of an interface for use when interacting with one or more pitch licensing packages.

FIG. 24 shows an example of an interface for use by an industry insider.

FIG. 25 shows an example of an interface for setting and editing user account settings.

FIG. 26 shows an example of an interface for viewing account activity.

FIG. 27 also shows an example of an interface for viewing account activity.

FIG. 28 also shows an example of an interface for viewing account activity.

FIG. 29 also shows an example of an interface for viewing account activity.

FIG. 30 shows an example of an interface for use by a user when interacting with the system.

FIG. 31 shows an example of an interface for browsing content.

FIG. 32 shows an example of an interface including a depiction of content from the perspective associated with an example control.

FIG. 33 shows an example of an interface including a depiction of content from the perspective associated with another example control.

FIG. 34 shows an example of an interface including a depiction of content from the perspective associated with another example control.

FIG. 35 shows an example of an expanded interface for use by a user when interacting with the system.

FIG. 35A shows an exemplary interface including a licensing package upgrade option.

FIG. 36 shows an exemplary interface including an additional “reviews” control.

FIG. 37 shows an example of an interface displaying review data in an expanded viewing area.

FIG. 38 shows an example of an interface that includes an additional “tags” control.

FIG. 39 shows an example of an interface displaying tag data in an expanded viewing area.

FIG. 40 shows an example of an interface including an exemplary activity report.

FIG. 41 shows an example of an interface including another exemplary activity report.

FIG. 42 shows an example of an interface including another exemplary activity report.

FIG. 43 shows an example of an interface including another exemplary activity report.

FIG. 44 shows an example of an interface including another exemplary activity report.

FIG. 45 shows an example of an interface including another exemplary activity report.

FIG. 46 shows an example of an interface including a pie chart graphic interpretation of content.

FIG. 47 shows an example of an interface including a pie chart graphic interpretation of content.

FIG. 48 shows an example of an interface including a bar chart graphic interpretation of content.

FIG. 49 shows an example of an interface including a bar chart graphic interpretation of content.

FIG. 50 is a flow diagram depicting an exemplary method for empowering content creators to market their own content without entering into onerous one-sided agreements with content promoters and marketers.

Like reference numbers and designations in the various drawings indicate like elements.

### DETAILED DESCRIPTION

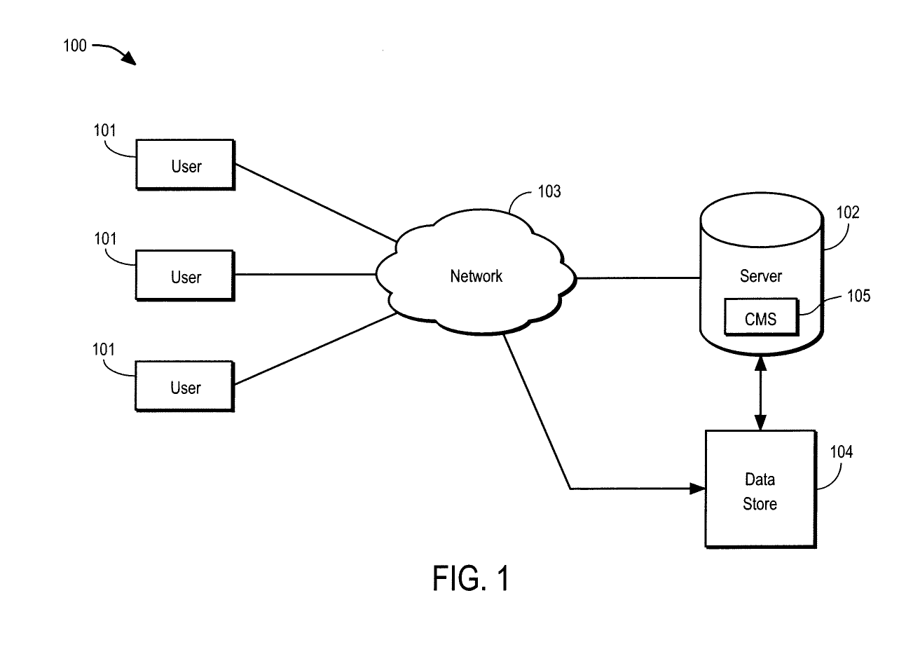

FIG. 1 shows a block diagram of an example system for content and content-related data and metadata processing, marketing, promotion, management, packaging, merchandising, fulfillment, delivery, distribution, licensing, and enforcement.

System 100 can be a computer-implemented environment wherein one or more users 101 can interact with a content management system 105 hosted on one or more servers 102 through a network 103. The content management system 105 contains software operations or routines for solving a content management problem. The users 101 can interact with the content management system 105 through a number of ways, such as over one or more networks 103. One or more servers 102 accessible through the network(s) 102 can host the content management system 105. It should be understood that the content management system 105 could also be provided on a stand-alone computer for access by a user.

The content-management system 105 can be an integrated web-based analysis tool that provides users flexibility and functionality for performing content management determinations and analysis or can be a wholly automated system. One or more data stores 104 can store the data to be analyzed by the content management system 105 as well as any intermediate or final data generated by the content management system 105. For example, data store(s) 104 can store raw or derived content-related data (e.g., metadata), for use in determining actions to be taken (e.g., based on particular analysis or constraints). Examples of data store(s) 40 can include relational database management systems (RDBMS), or a multi-dimensional database (MDDB), such as an Online Analytical Processing (OLAP) database, etc.

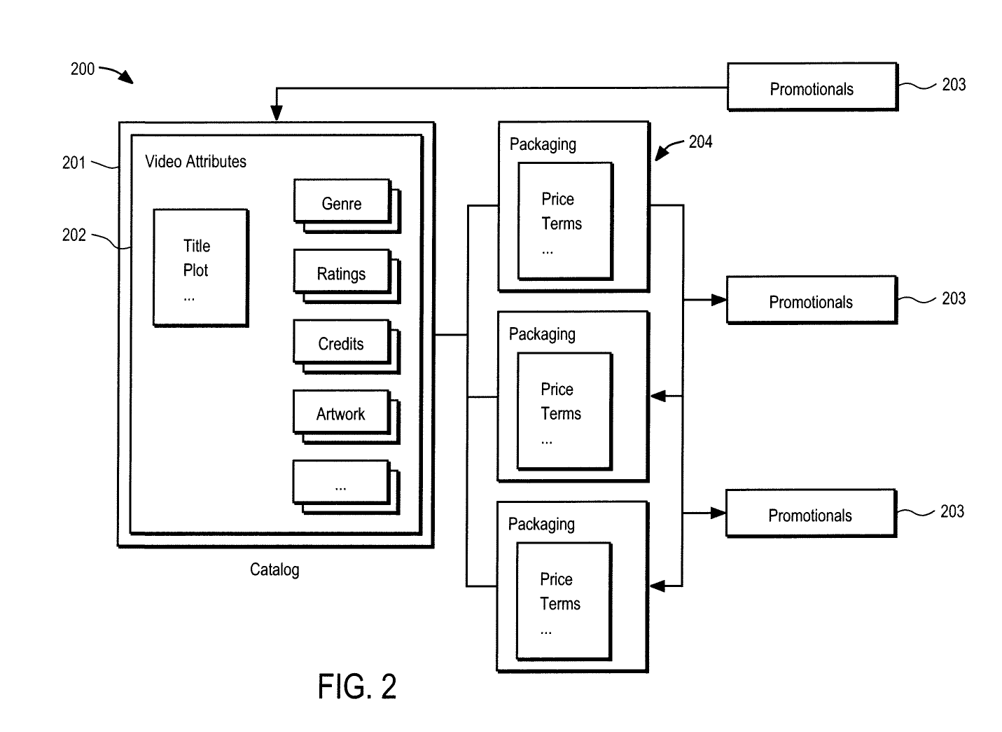

FIG. 2 shows an exemplary display 200 of certain components within a content management system (e.g., a system for FIG. 1 shows a block diagram of an example system for content and content-related data and metadata processing, marketing, promotion, management, packaging, merchandising, fulfillment, delivery, distribution, licensing, and enforcement). In some implementations, the system can include a catalog 201. The catalog can include static elements (e.g., data) corresponding to aspects of the content that remain constant (e.g., or unchanging), in the system. For example, a catalog can include static elements corresponding to aspects of multimedia content, such as video (e.g., film) content 202. In this example, video content 202 can include certain video attributes (e.g., title, plot, genre, ratings, credits, artwork, etc.). In other examples, a catalog can include static elements corresponding to other types of multimedia content such as game content, audio content, e-books, software, electronic photos, and electronic artwork. Content can be added or deleted from the catalog, thus the catalog can be dynamic. The content within the catalog (e.g., the plot of a movie within the catalog), is editable but does not generally change and thus the content can be static. Thus, catalog data can be a globally constant description (e.g., of defined structured data fields) that includes individual references corresponding to the content of each object (e.g., a video) individually.

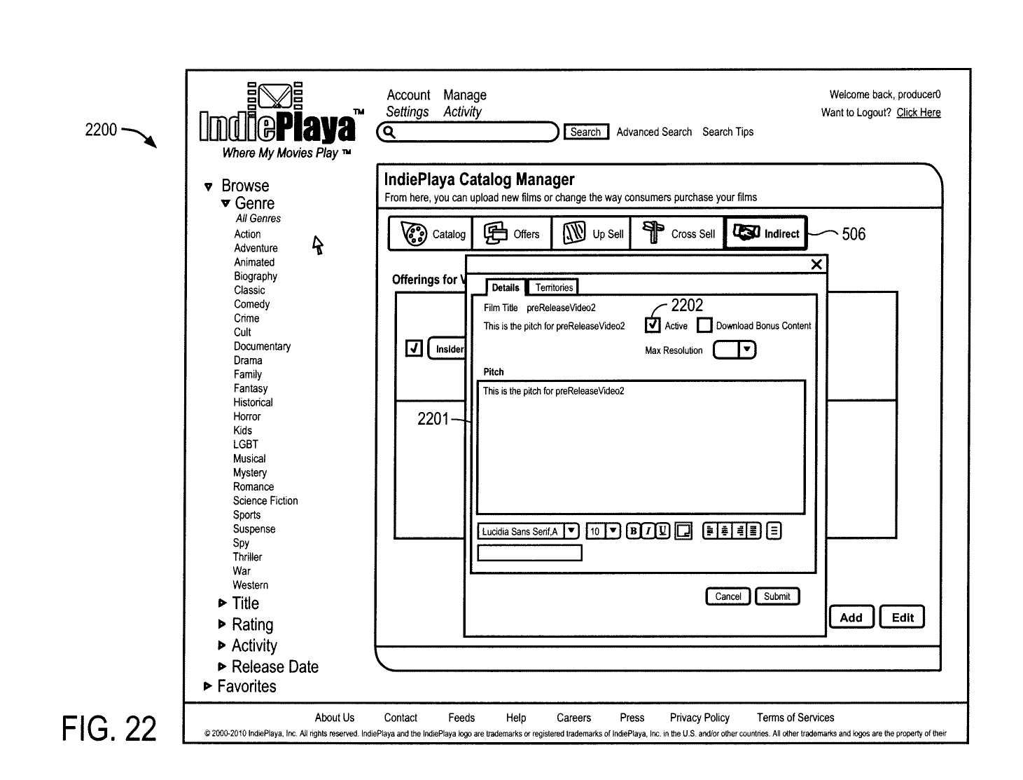

In some implementations, the system can include one or more promotional functionalities 203. For example, a promotional functionality 203 can include a limited ability to promote content without the ability to sell the content. In this example, a content creator can promote content prior to the content being available to a user (e.g., for purchase). In another example, a third party (e.g., someone other than the content creator or the content user) can create promotions (e.g., as an influencer) for a larger audience. Additionally, a third party can receive a commission for promoting content without having a license to sell the content. This aspect will be discussed in greater detail with respect to FIGS. 22-24 below.

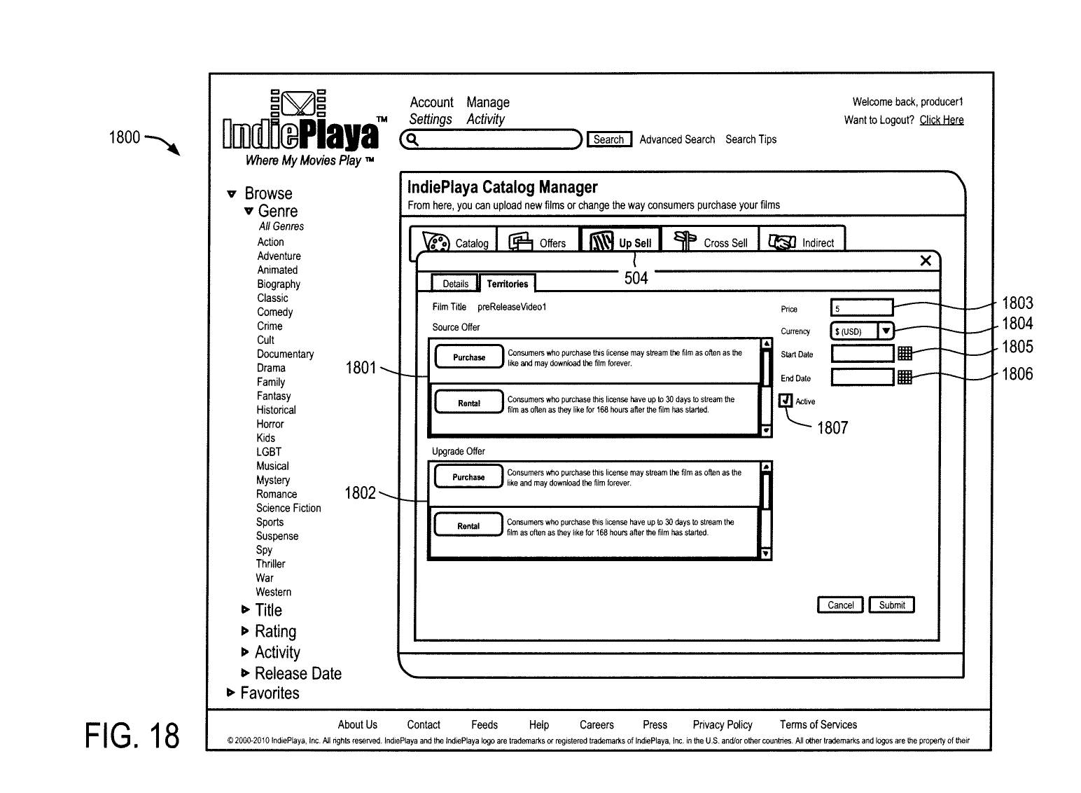

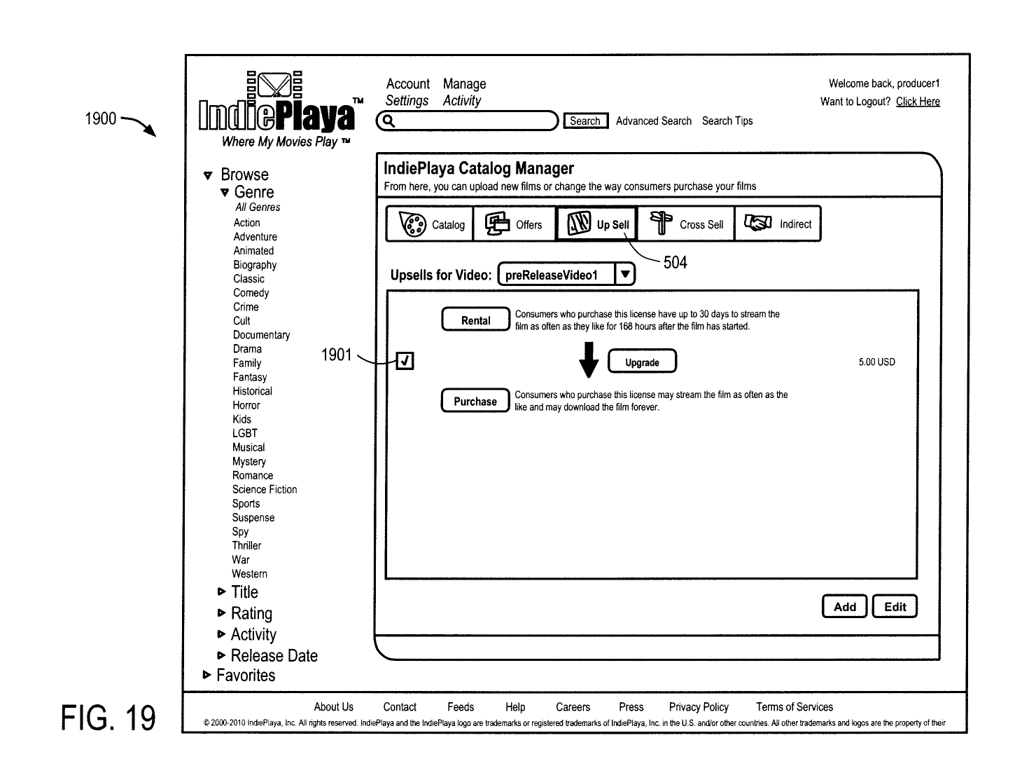

In some implementations, a promotional functionality 203 can include an ability to up-sell content or content properties (e.g., using a license). For example, a content creator can grant a license to a user allowing the user to use content. Additionally, the terms of a license can be expanded with respect to a property of content (e.g., quality or resolution). In an example of such implementations, when a user exhibits an interest in paying a first amount for a limited use license to use content for a predefined time period, the content creator can dynamically create and offer the user another license option to use the same content at a second amount and for a different (e.g., a greater) period of time. For example, when a user selects a content rental option or rents content (e.g., a video) for $5.00, the content creator (e.g., the filmmaker), is notified or otherwise made aware (e.g., by requesting a report). Once aware, the content creator can dynamically create and offer a content purchase option (e.g., reduce a purchase price from $15.00 to $11.00), to that user. This aspect will be discussed in greater detail with respect to FIGS. 18-19 below.

In some implementations, promotional functionality 203 can include an ability to cross-sell content. The cross-sell option can allow the content creator the ability to familiarize the user with more content (e.g., content the user may not otherwise be aware of). For example, when a user exhibits an interest in learning about content, the content creator can dynamically create a reference to related content. In this example, when a user selects a page on which content is hosted, the content creator is notified or otherwise made aware. Once aware, the content creator can dynamically create a reference to related content (e.g., if you like A, you may be interested in B).

In another example, when a user exhibits an interest in licensing content, the content creator can dynamically create and offer the user another license option for similar content. In this example, when a user selects a content rental or purchase option corresponding to first content (e.g., a video), the content creator is notified or otherwise made aware. Once aware, the content creator can dynamically create and offer a content purchase option for similar second content (e.g., if you like A, you can buy B for $3.00).

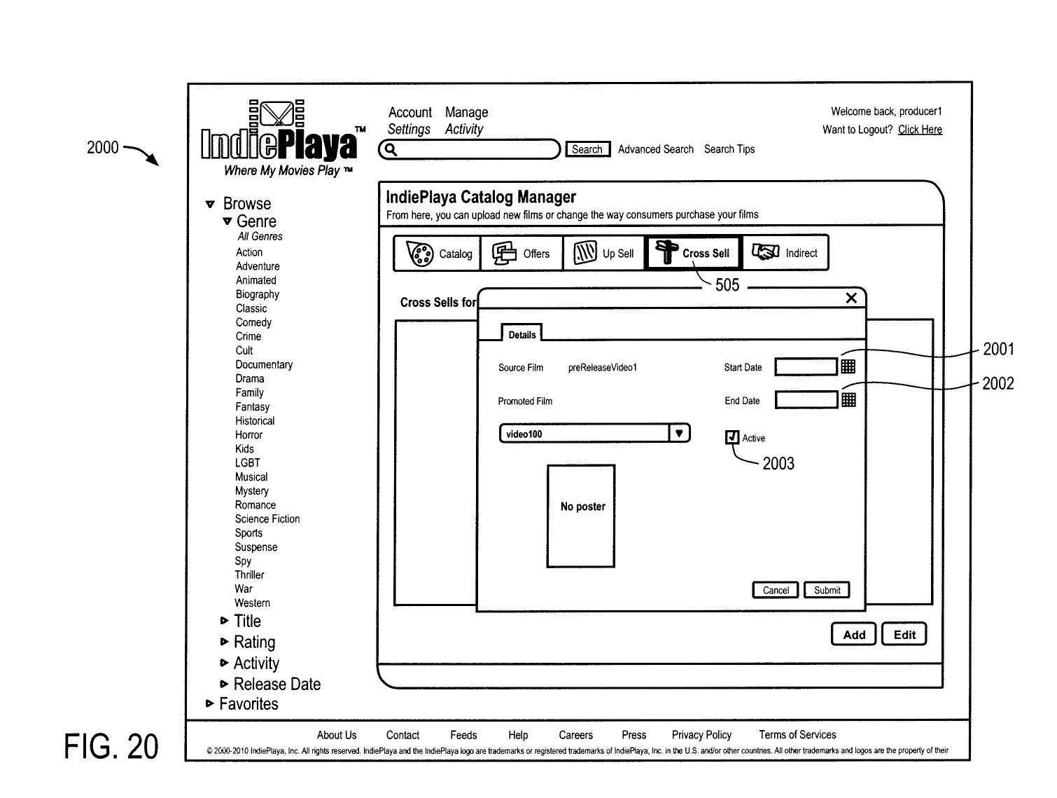

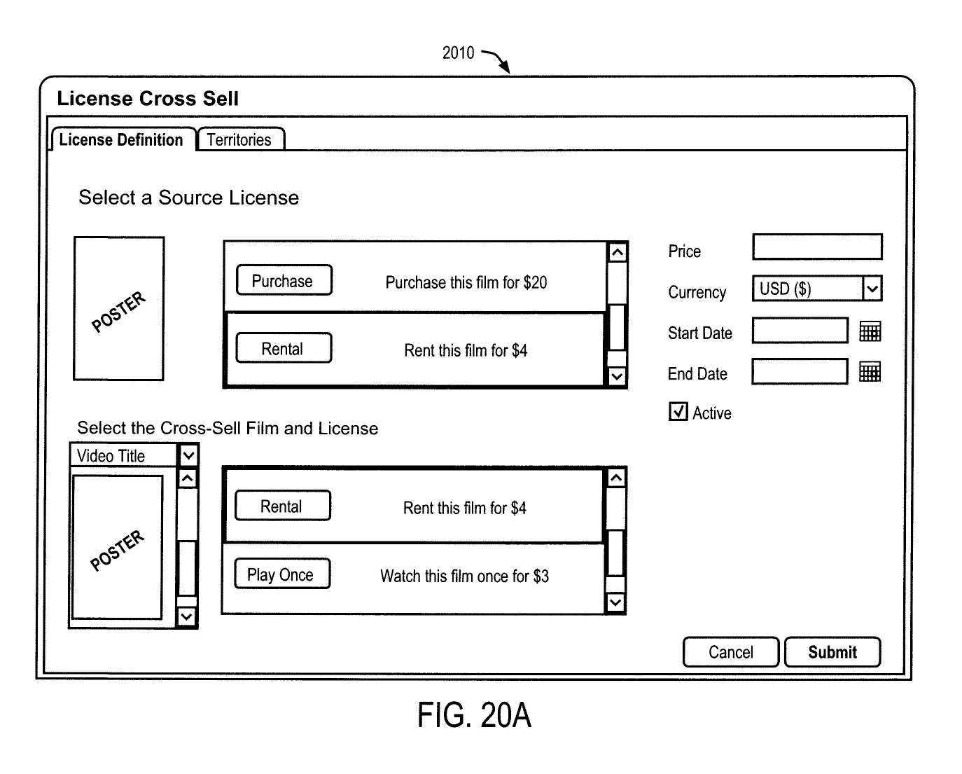

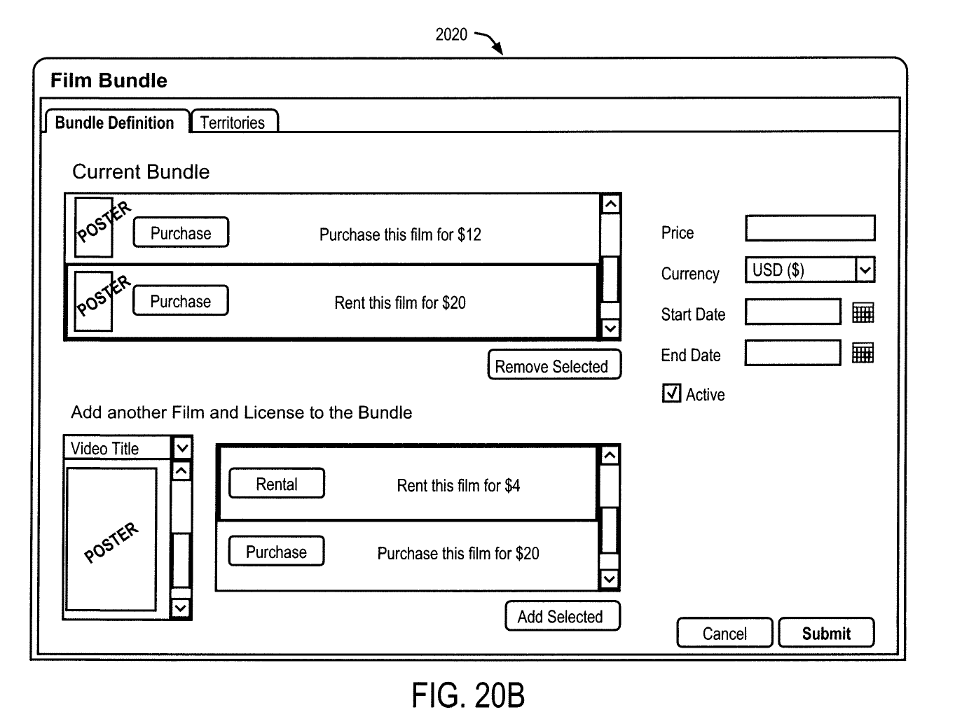

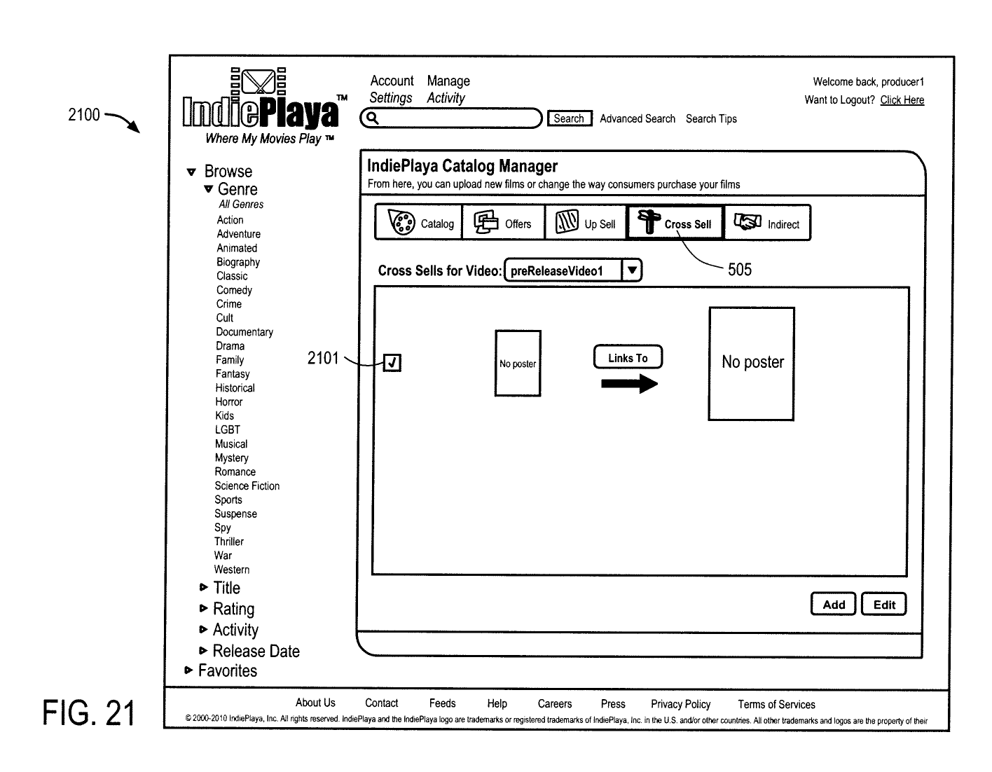

In yet another example, when a user exhibits an interest in licensing content, the content creator can dynamically create and offer the user an additional license for similar content. In this example, when a user selects a web page or panel upon which content is hosted, the content creator is notified or otherwise made aware. Once aware, the content creator can dynamically create and offer a content purchase option for the content on the current webpage or panel as well as one or more additional purchase options for the similar content (e.g., if you like A, you can buy A and B together for $10.00). These cross-sell aspects will be discussed in greater detail with respect to FIGS. 20, 20A, 20B, and 21 below.

In some implementations, using the catalog 201, one or more licensing options or alternatives (e.g., licensing packages 204), can be dynamically generated by a content creator using the system. In other implementations, using the catalog 201 and the promotional functionality 203, one or more licensing options (e.g., licensing packages 204), can be dynamically generated by a content creator using the system. Licensing packages 204 can include the price and terms of a licensing agreement between a content creator and a user. A user can be concurrently presented with one or more licensing options. For example, when the content is film, licensing options can include but are not limited to a “high definition” (“HD”) option (i.e. 720p video resolution or greater), an option that defines the terms of a rental agreement, an option that defines the terms of a purchase agreement, an option indicating whether the content is downloadable, or an option indicating whether the user has access to bonus content.

Additionally, in some implementations, one or more additional licensing packages 204 can be dynamically generated and presented to the user based upon user interaction with the system. For example, as noted above, a content creator can dynamically offer the user an up-sell or a cross-sell based upon a user selection. In some implementations, when a user executes a first license package 204 (e.g., rents content), and accepts an offer to execute a second license package 204 (e.g., purchase the rented content), the first license can expire upon the execution (e.g., acceptance) of the second offer. In other implementations, when a user executes a first licensing package 204 (e.g., purchase of a standard definition version of a film), and accepts an offer to execute a second license package 204 (e.g., rent a high definition version of the film), the first license can run concurrently with the second offer. In still other implementations, when a user executes a first licensing package 204 (e.g., purchase of a standard definition version of a film), and accepts an offer to execute a second license package 204 (e.g., rent a high definition version of the film), the first license can be suspended for the duration of the second offer. For example, the first license can be selectively or automatically reinstated upon completion of the second offer.

Additionally, in some implementations, licensing packages 204 can be activated and deactivated. For example, a licensing package 204 can be activated or deactivated manually (e.g., by the content creator), automatically (e.g., by the system), or in accordance with one or more predefined settings (e.g., set by a content creator). Dynamic creation of licensing packages 204 will be discussed in greater detail with respect to FIGS. 18-24 below.

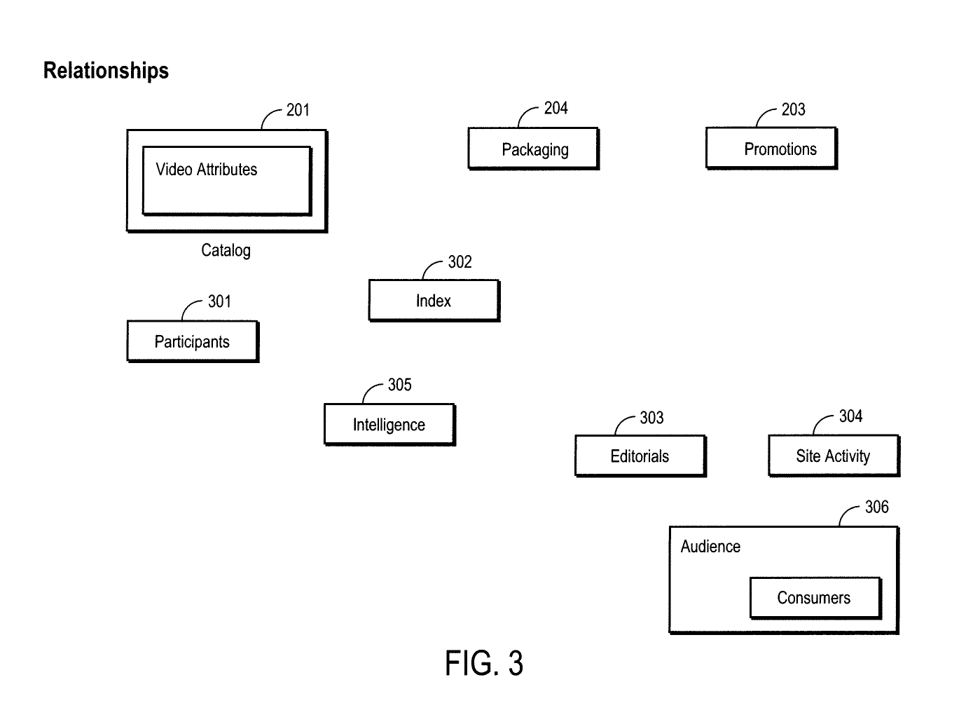

FIG. 3 shows an exemplary display 300 of additional relationships within the system. In addition to relationships between the catalog 201, the promotional functionality 203, and the licensing packages 204, in some implementations, the system can include additional relationships. Additional relationships can exist among content creators (e.g., participants 301), and the users of content (e.g., audience 306). Relationships can be developed based upon interactions with one or more system components. For example, as noted above, using the catalog 201 and the promotional functionality 203, a participant 301 can offer one or more licensing packages 204 to an audience member 306 (e.g., a audience). In this example, participants 301 can include a content provider such as anyone offering a license for content (e.g., a filmmaker or a distributor), or anyone participating in the creation of the content (e.g., actors, writers, or directors).

In some implementations, the system can include a searchable index 302 which can facilitate site navigation and organization of raw (e.g., unprocessed) and derived (e.g., processed) data corresponding to user interaction with the system. In some implementations, the index 302 can include a hierarchical arrangement of un-weighted attributes corresponding to content in the system. In other implementations, the index 302 can include a hierarchical arrangement of weighted attributes corresponding to content in the system. Additionally, attributes can be weighted differently according to a plurality of factors or words. For example, a content creator (e.g., a filmmaker), can determine that a particular word is of greater importance when searching the index. In this example, this term can be assigned a greater weight and thus it would appear higher up on a list of search results for that term.

Audience 306 can interact with the index 302 (e.g., to search and locate data). In some implementations, based upon audience 306 interaction with the index 302, static data from the catalog 201 and one or more licensing packages 204 can be presented to audience 306. In some implementations, site activity 304 (e.g., audience interaction with a website), can be indexed 302 and stored for later analysis. In these implementations, audience interaction can include all activity up to and including a purchase. Thus, even if a purchase is not made, data related to audience interaction with content on the website can be indexed and used for later analysis. In these implementations, audience interaction can include all activity following a purchase. Thus, post purchase data related to audience interaction with content on the website can also be indexed and used for later analysis.

In some implementations, audience 306 can provide feedback to the system using an editorial functionality 303. For example, audience 306 can critique content (e.g., write a review), or rate content. In another example, audience 306 can participate in a conversation or on-line dialog about the content. In this example, audience 306 can participate in a chat room dialog with one or more participants 301. In yet another example, an audience member 306 can generate a review that can be posted or displayed (e.g., on a social network website), where the audience member 306 and one or more other users can participate in a dialog about the content.

In some implementations, site activity 304 and editorial information 303 are combined to generate intelligence 305 that can be used to generate new promotional functionalities 203 and new licensing packages 204. In some implementations, new promotional functionalities 203 and new licensing packages 204 can be based on intelligence 305 and generated manually (e.g., by a participant 301). In some implementations, new promotional functionalities 203 can be generated automatically (e.g., by the system), based upon prior participant 301 or audience 306 interactions with the system or based on one or more predefined settings.

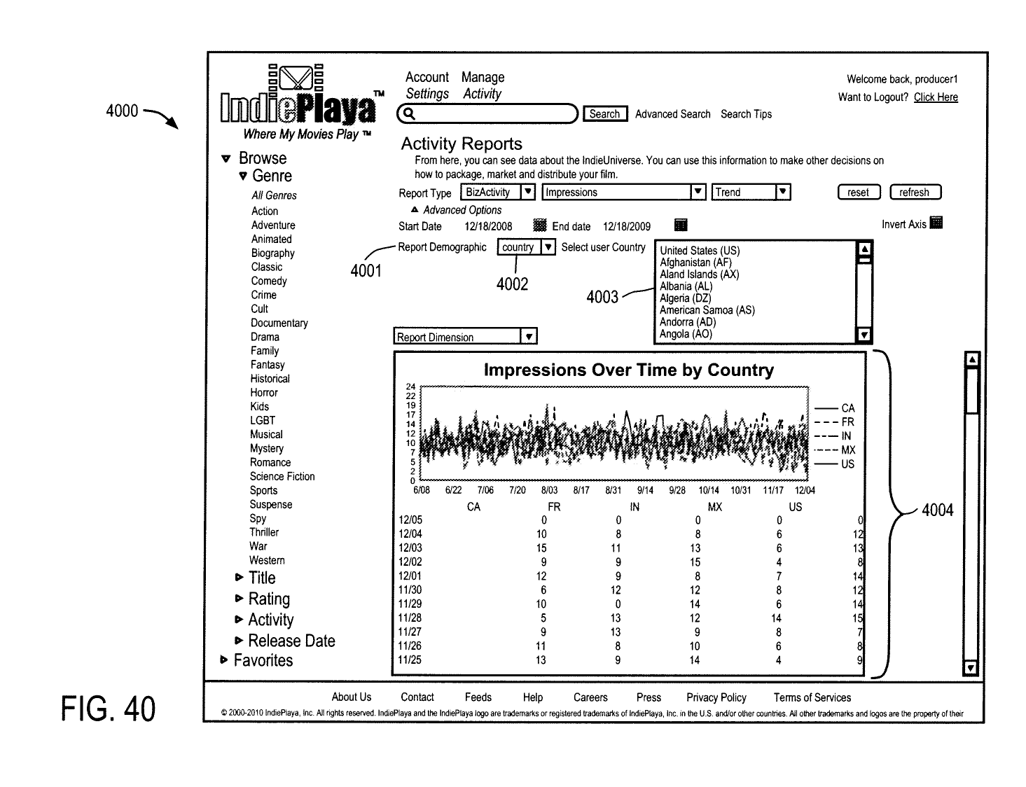

In some implementations, intelligence 305 can include raw (e.g., unprocessed) and/or derived (e.g., processed) data. Intelligence 305 can be dynamic (e.g., the return of content by a dissatisfied audience can automatically change the intelligence 305). In some implementations, intelligence 305 can be processed and statistics can be automatically generated (e.g., in real-time) based upon website activity (e.g., audience 306 interaction). Generated statistics can be used (e.g., by the system) to generate one or more reports (e.g., based upon audience 306 interaction). For example, reports can be used to examine account histories and make recommendations (e.g., for a single account or for a group of related accounts). Reports will be discussed in greater detail below with respect to FIGS. 40-49. In some implementations, generated statistics can be compared to one or more pre-defined benchmarks or thresholds to determine whether promotional functionalities 203 and licensing packages 204 need to be adjusted. Adjustments to promotional functionalities 203 and licensing packages 204 can allow a participant 301 to define and refine efficient ways to target new and existing audience members 306 based upon system intelligence 305.

Defining and refining efficient ways to target new and existing audience members 306 based upon system intelligence 305 can be done dynamically. For example, as audience 306 interest changes (e.g., over time), a content creator can use the system to evaluate user interest in real-time (e.g., automatically). Additionally, a content creator can adjust promotional functionalities 203 and licensing packages 204 in real-time. These adjustments can be stored along with data and logic used to make the adjustments. Stored data and logic corresponding to a content creators adjustments can then be used by the system to dynamically evaluate user interest (e.g., in real-time) and without human intervention (e.g., by the content creator). Dynamic evaluations made by the system can also be adjusted by a content creator at any time.

In some implementations, static catalog data 201 can be a globally constant description (e.g., of defined structured data fields) that includes individual references corresponding to the content of each object (e.g., a video) individually. In these implementations, a globally constant description of static catalog data 201 can allow a content creator to organize data in accordance with user interest and user preference with respect to content interaction. Additionally, other data corresponding to the distribution and management of content (e.g., content price and related terms of restriction), can be defined dynamically (e.g., in accordance with intelligence 305). This decoupling facilitates data aggregation, cross-content recommendations, and the dynamic (e.g., “on-the-fly”) creation and distribution of licensing packages (e.g., in real-time). For instance, all users can benefit from the ability to interact with universal editorial information 303 while concurrently having individualized licensing packages 204 available (e.g., customized on an individual user basis).

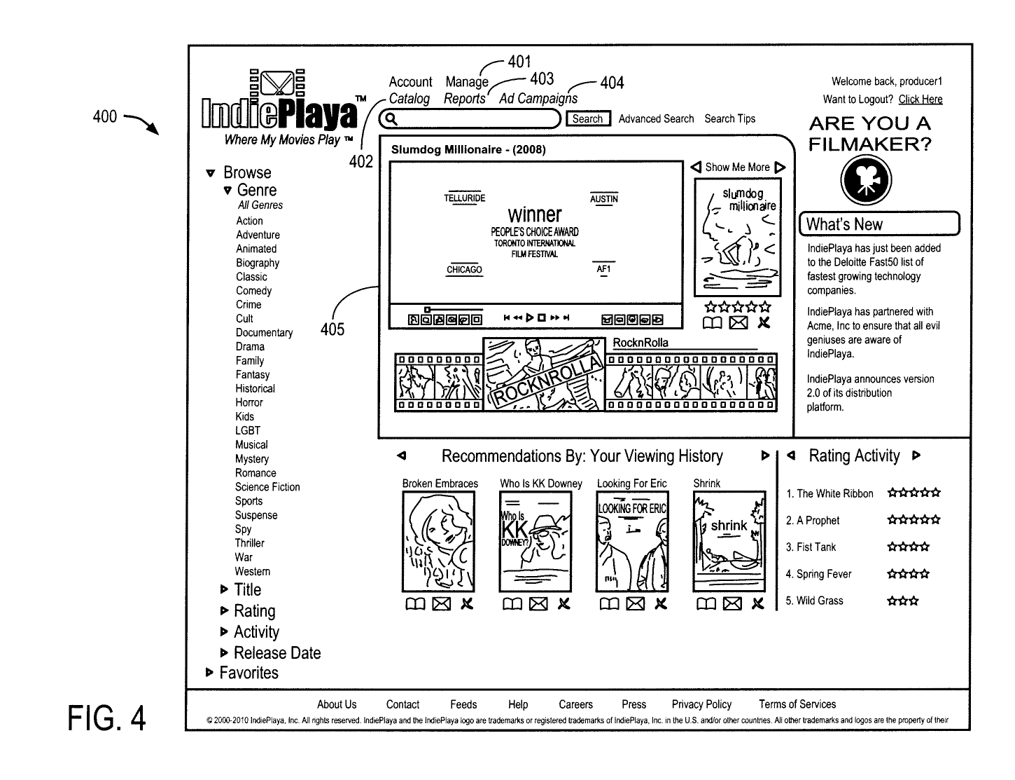

FIG. 4 shows an exemplary interface 400 for use by a content creator (e.g., a participant). Using the interface 400, the content creator can manage content. For example, content interface 400 can include one or more controls for managing 401 content. Controls for managing content can include, but are not limited to, a catalog control 402, a reports control 403, and an ad campaign control 404. Additionally, interface 400 can include a viewing area 405 (e.g., a window), for interacting with (e.g., viewing), content.

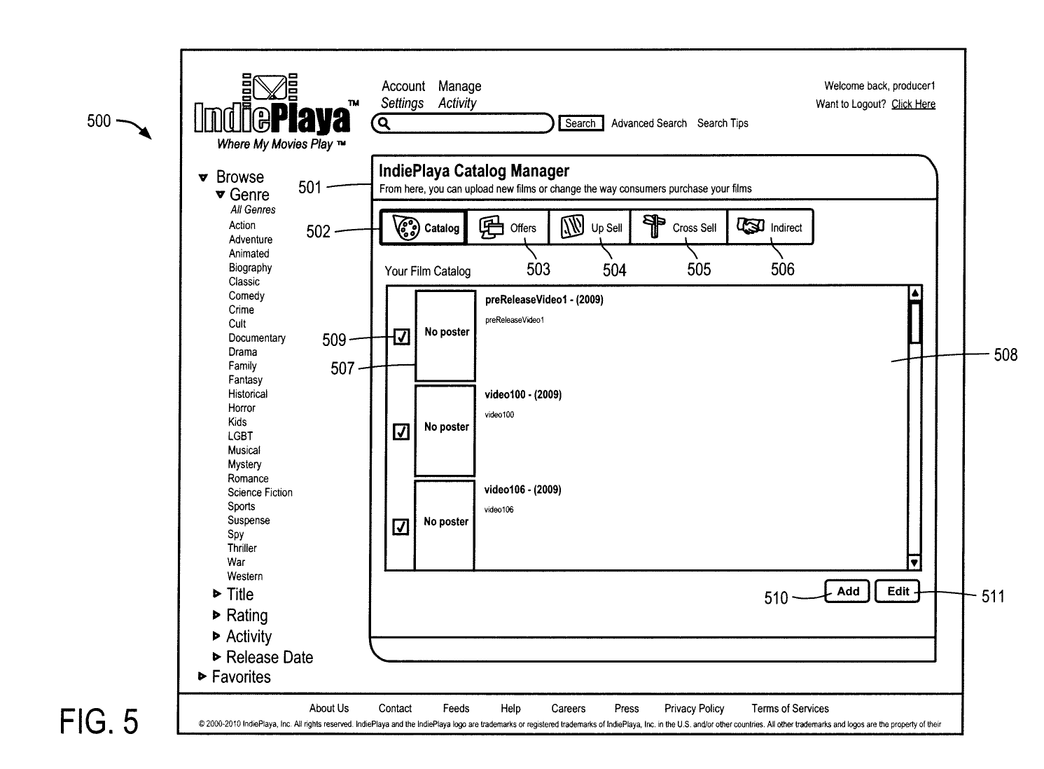

FIG. 5 shows an exemplary interface 500 for a catalog control 402. Activating catalog control 402 can cause the system to generate catalog interface 500. In some implementations, catalog interface 500 can include catalog manager 501. In these implementations, catalog manager 501 can include one or more controls that can be used to interact with content in catalog 201. Exemplary controls can include any combination of film catalog control 502, offers control 503, up-sell control 504, cross-sell control 505, and indirect control 506. Activating the film catalog control 502 can cause the system to generate a list of content (e.g., film content) created by the content creator using the system (e.g., as recognized by a unique challenge such as a log-in username and password). The list can include any combination of a visual representation of the content 507, a textual description of the content 508, and a visual indication 509 (e.g., a checkbox) indicative of whether the content is active or inactive (e.g., a checked box can indicate active content and an unchecked box can indicate inactive content). In some implementations, using an add control 510, the content creator can add content to the system, and using the edit control 511, the content creator can edit content in the system.

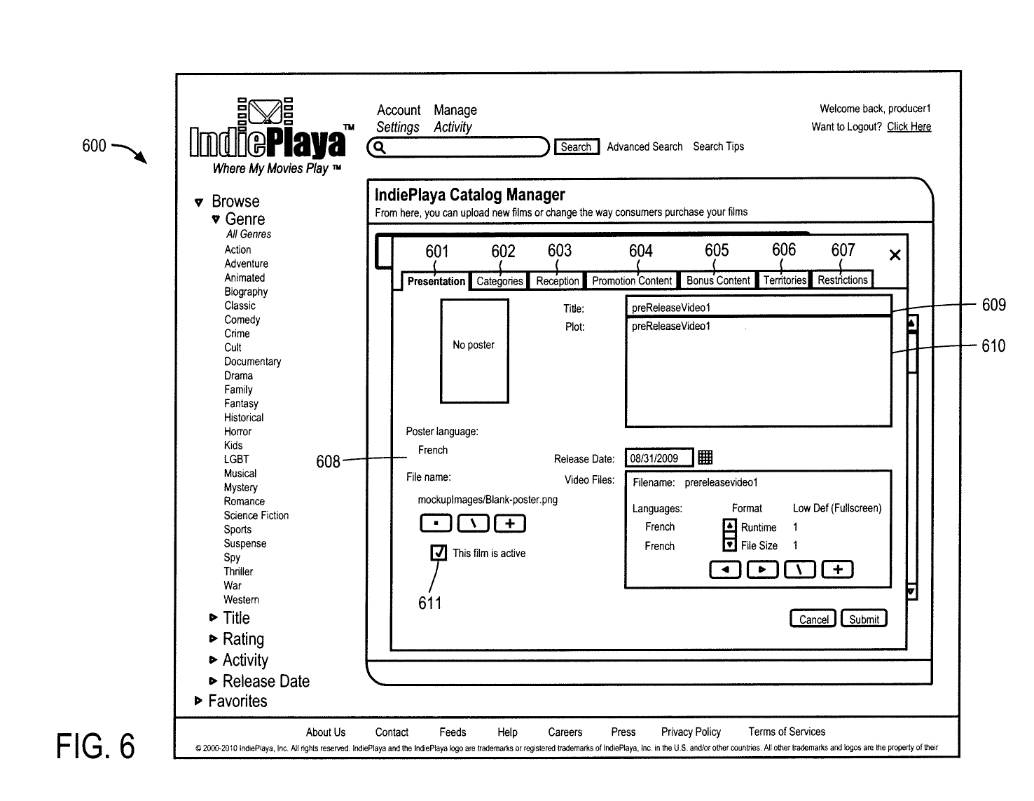

FIG. 6 shows an exemplary interface 600 for adding or editing content using a control (e.g., film catalog control 502), within catalog manager 501 (from FIG. 5). The interface 600 can include one or more controls for adding or editing content. For example, interface 600 can include any combination of presentation control 601, categories control 602, reception control 603, promotion content control 604, bonus content control 605, territories control 606, and restrictions control 607. Activating presentation control 601 can cause the system to generate presentation interface 608 including one or more areas for entering information about content. For example, presentation interface 608 can include title area 609 (e.g., for entering the title of film content), and plot area 610 (e.g., for entering text regarding the plot of film content). The presentation interface 608 can also include active control 611 corresponding to visual indication 509 of FIG. 5. Selecting active control 611 can be an indication that the content is active, and de-selecting active control 611 can be an indication that the content is inactive. Additionally, selecting active control 611 can cause the system to check visual indication 509 for the content on interface 500 of FIG. 5 (e.g., indicating that the content is active).

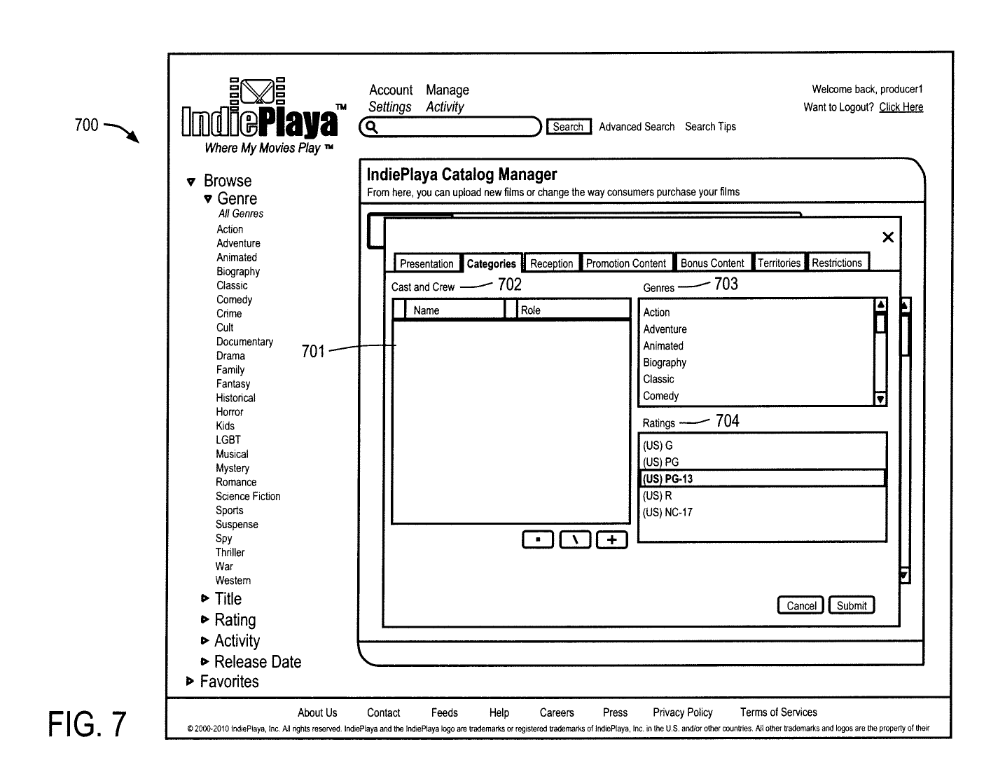

FIG. 7 shows another example interface 700 for adding or editing content using a control (e.g., film catalog control 502), within catalog manager 501 (from FIG. 5). Activating the categories control 602 in FIG. 6, can cause the system to generate categories interface 701 including one or more areas for entering information about content. For example, categories interface 701 can include cast and crew area 702 (e.g., for entering information about the cast and crew of film content), genres area 703 (e.g., for entering information about the genre of film content), and ratings area 704 (e.g., for entering information about the rating of film content).

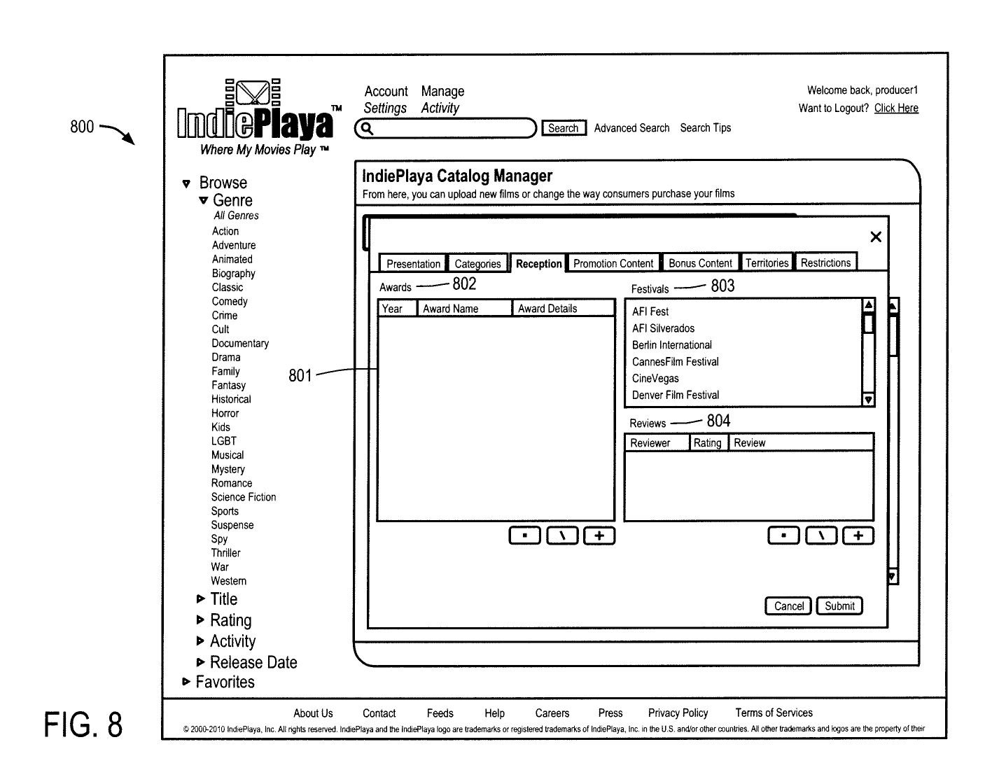

FIG. 8 shows another exemplary interface 800 for adding or editing content using a control (e.g., film catalog control 502), within catalog manager 501 (from FIG. 5). Activating reception control 603 in FIG. 6, can cause the system to generate reception interface 801 including one or more areas for entering information about content. For example, reception interface 801 can include any combination of awards area 802 (e.g., for entering information about awards given to film content), festivals area 803 (e.g., for entering information about festivals including film content), and reviews area 804 (e.g., for entering information about professional reviews of film content).

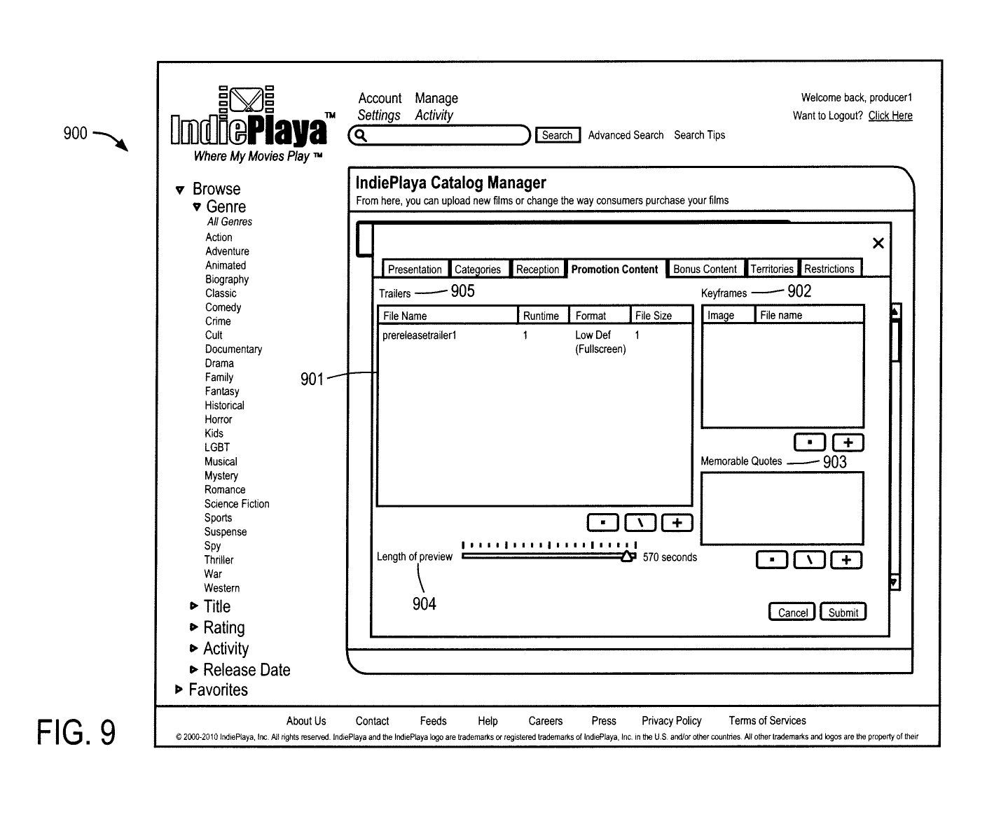

FIG. 9 shows another exemplary interface 900 for adding or editing content using a control (e.g., film catalog control 502), within catalog manager 501 (from FIG. 5). Activating promotion content control 604 in FIG. 6, can cause the system to generate promotion content interface 901 including one or more areas for entering information about content. For example, promotion content interface 901 can include any combination of trailers area 905 (e.g., for entering information about trailers of the film content), key frames area 902 (e.g., for entering information about still images or key frames from the film content), and memorable quotes area 903 (e.g., for entering information about memorable quotes within the film content). Promotion content interface 901 can also include length of preview control 904 (e.g., for setting a length of a preview of content).

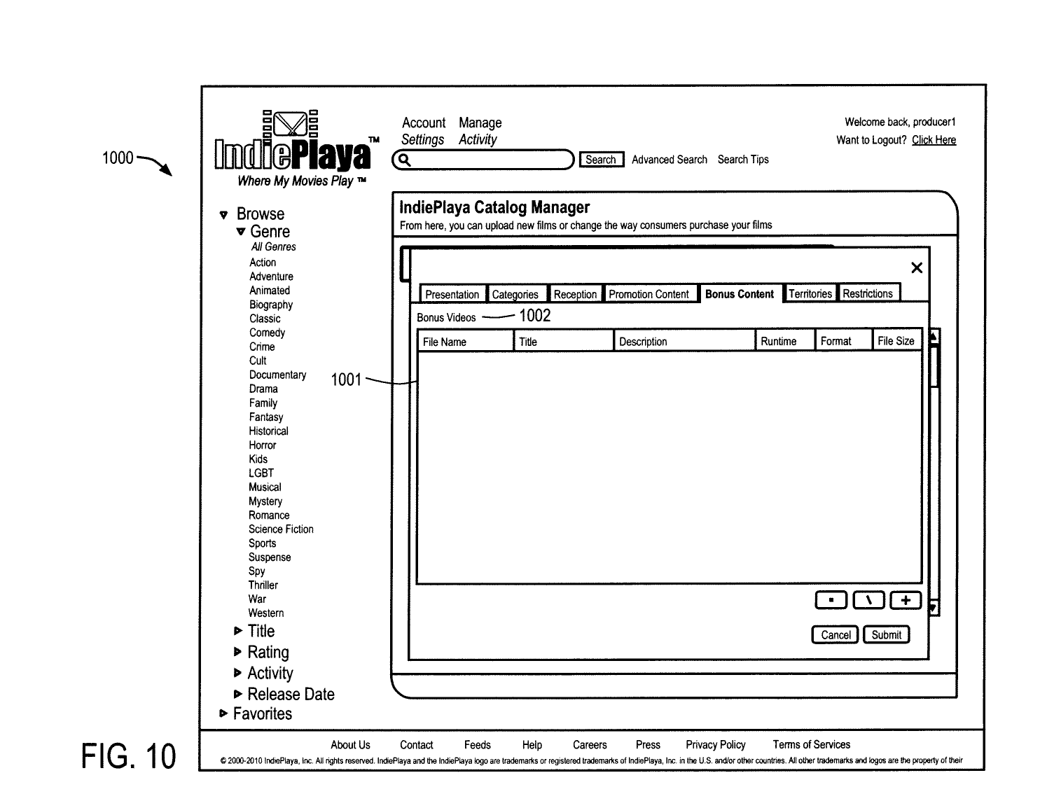

FIG. 10 shows another exemplary interface 1000 for adding or editing content using a control (e.g., the film catalog control 502), within catalog manager 501 (from FIG. 5). Activating bonus content control 605 in FIG. 6, can cause the system to generate bonus content interface 1001 including one or more areas for entering information about bonus content. In some implementations, bonus content can include only previously existing content (e.g., edited in a new way). In some implementations, bonus content can include both previously existing content as well as new content (e.g., previously existing content with new annotations and/or commentary). In some implementations, bonus content can include only new content (e.g., related but previously unavailable content). For example, bonus content interface 1000 can include bonus videos area 905 (e.g., for entering information about bonus videos corresponding to or available with the film content). In some implementations, a content creator can make bonus content available dynamically as a licensing package. In these implementations, the bonus content licensing packages can run independent of or dependent upon any other licensing agreement (e.g., rental or purchase license). Additionally, a content provider can make bonus content available on the system dynamically, and at any time. Any bonus content made available on the system can be downloaded by a user at any time, once the user has purchased the corresponding bonus content licensing agreement.

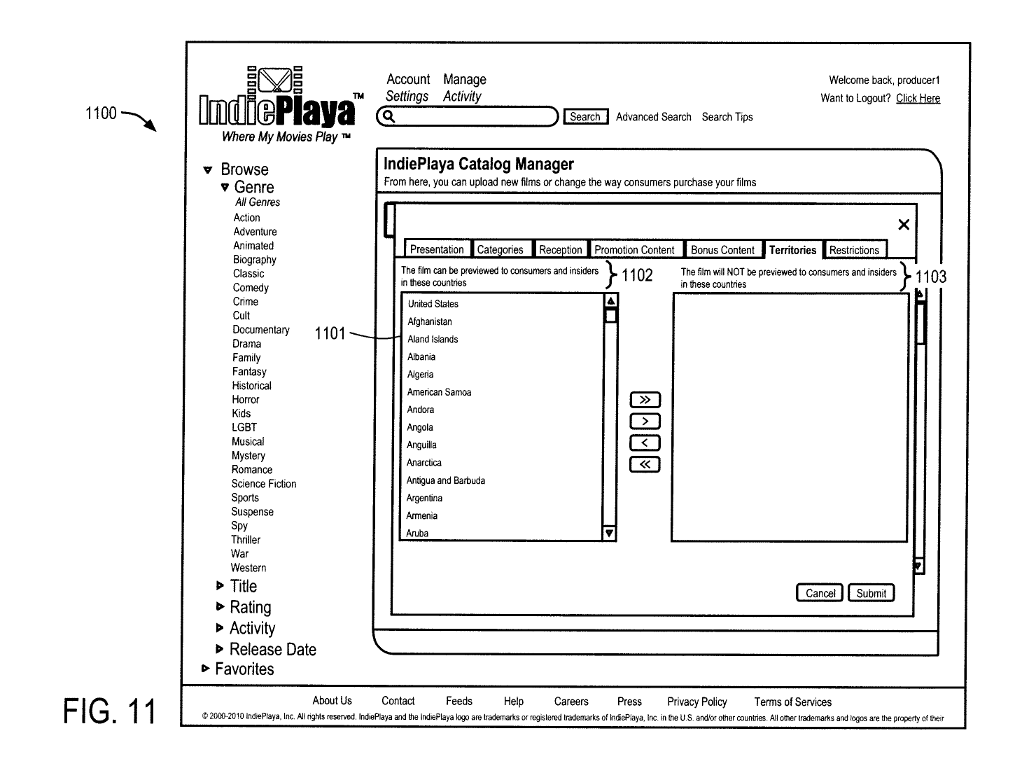

FIG. 11 shows another exemplary interface 1100 for adding or editing content using a control (e.g., the film catalog control 502), within catalog manager 501 (from FIG. 5). Activating territories control 606 in FIG. 6, can cause the system to generate territories interface 1101 including one or more areas for entering information about content. For example, territories interface 1101 can include preview area 1102 for selecting one or more geographic regions (e.g., cities, states, towns, regions, countries, sets of countries, etc.) and/or Internet domains (e.g., a predetermined set of IP addresses, top level domains, country code top level domains, websites, Internet service providers (ISPs), etc.), from which the content creator will allow users to preview the content (e.g., the film content). In the example depicted in FIG. 11, if the content creator would like to exclude any users within a particular country from being able to preview the content, the content creator can select that country (e.g., by highlighting the country and activating a select button). Once selected, the country will appear in no preview area 1103 and users in that country will not be permitted to preview the content.

In another example, the content creator can choose to not permit previews of the content in all countries except a select few. In this example, the content creator can select all the countries listed in preview area 1102 (e.g., by highlighting those countries and activating a select button). The list of countries will then appear in no preview area 1103. To select particular countries allowed to preview the content, the content creator would then select that country in no preview area 1103 (e.g., by highlighting the country and activating a select button). Once selected, the country will appear in preview area 1102 and users in that country will be permitted to preview the content. In some implementations, territories interface 1101 can assist a content creator in conforming to the terms of a geographically restrictive third-party licensing agreement.

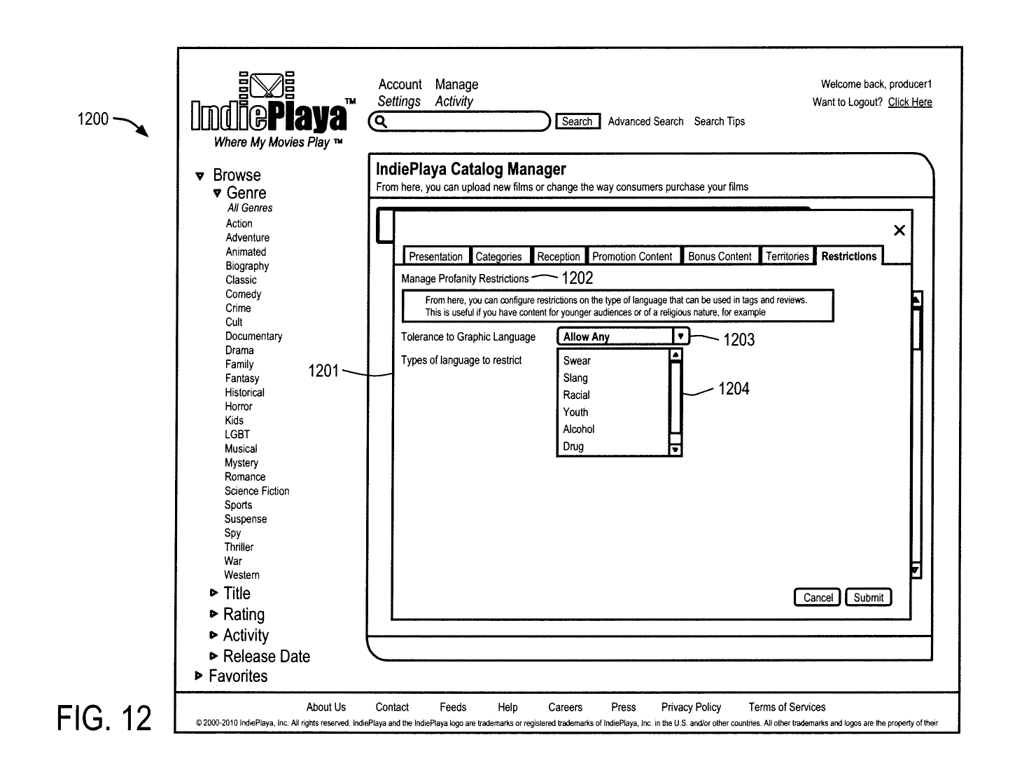

FIG. 12 shows another exemplary interface 1200 for adding or editing content using a control (e.g., the film catalog control 502), within catalog manager 501 (from FIG. 5). Activating restrictions control 607 in FIG. 6, can cause the system to generate restrictions interface 1201 including one or more areas for entering information about content. For example, restrictions interface 1200 can include manage profanities area 1202 used to restrict the type of language allowed in tags and reviews (e.g., submitted by audiences providing feedback to the system using editorial functionality 303). The manage profanities area 1202 can include any combination of tolerance to graphic language area 1203 (e.g., indicating a permitted level of tolerance), and types of language to restrict area 1204 (e.g., by subject matter).

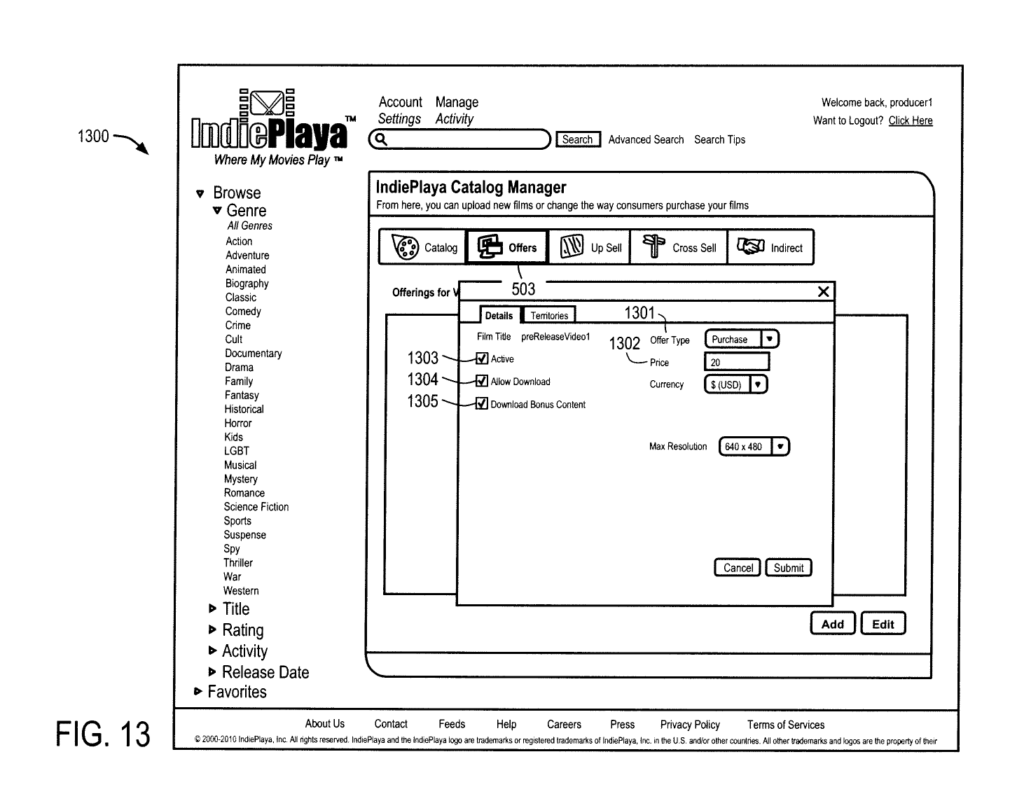

FIG. 13 shows an exemplary interface 1300 for creating offers (e.g., licensing packages) using a control (e.g., the offers control 503), within catalog manager 501 (from FIG. 5). In some implementations, offers (e.g., licensing packages) can be dynamically created (e.g., by a content creator) at any time, and offered as a licensing option (e.g., to a user). In some implementations, interface 1300 can include one or more controls for defining a licensing package. For example, a licensing option can include the purchase of content (e.g., film content). In this example, using offer type control 1301, a content provider (e.g., a participant), can select a purchase option. Additionally, a content provider can set a price for the purchase option using the price control 1302. In some implementations, additional controls (e.g., checkboxes), can be used to set one or more parameters of a licensing package (e.g., whether a licensing package is active 1303, whether a content download will be allowed 1304, or whether bonus content can be downloaded 1305). Once all the terms of a licensing package have been determined, the licensing package can be generated and displayed.

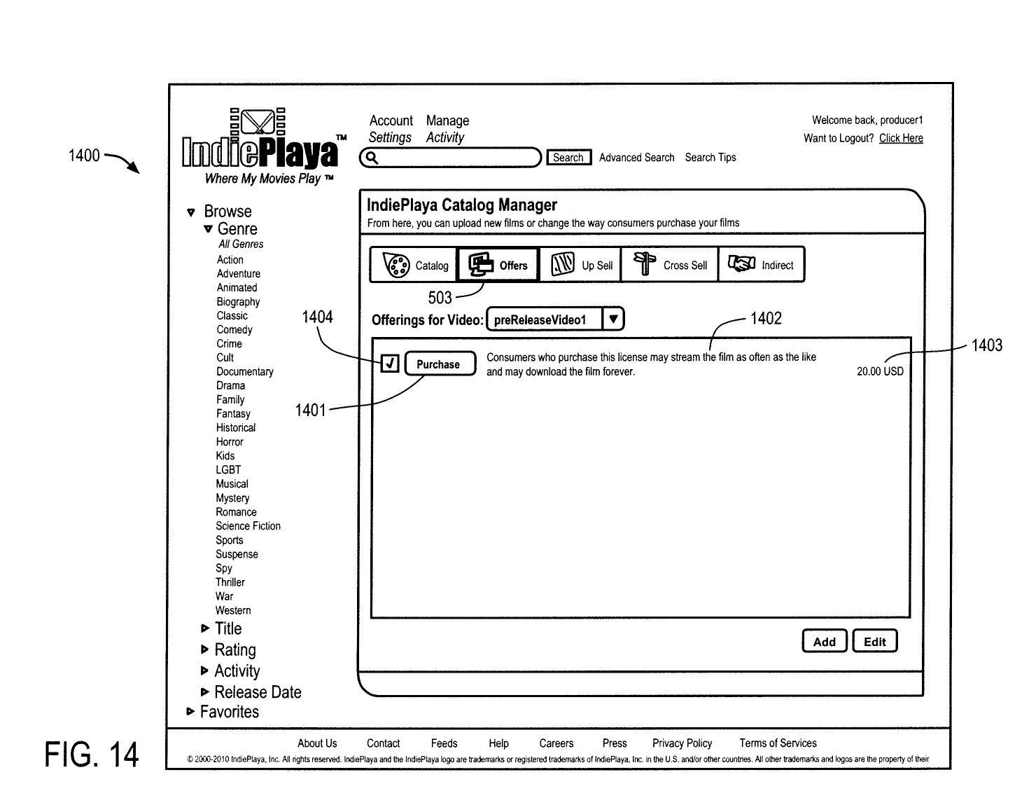

FIG. 14 shows an exemplary interface 1400 for use when interacting with one or more licensing packages. As noted above, once a licensing package has been generated, the licensing package can be displayed. In some implementations, the display for a purchase licensing package can include purchase button 1401. Activating purchase button 1401 allows the user (e.g., an audience), to purchase content associated with a purchase licensing package. In some implementations, additional information can be displayed (e.g., a description of the licensing package 1402, or a price of the licensing package 1403). Additionally, as noted above, selecting active control 1303 (from FIG. 13), can cause the system to check visual indication 1404 for the purchase licensing package on interface 1400 (e.g., indicating that the purchase licensing package is active).

In some implementations, the system can also generate one or more rental licensing packages. For example, the system can generate a rental licensing package in which a user can use (e.g., play) the content any number of times within a period of time defined by the license. In another example, the system can generate a rental licensing package in which a user can use (e.g., play) the content n number of times (e.g., one time, two times, three times, . . . n times).

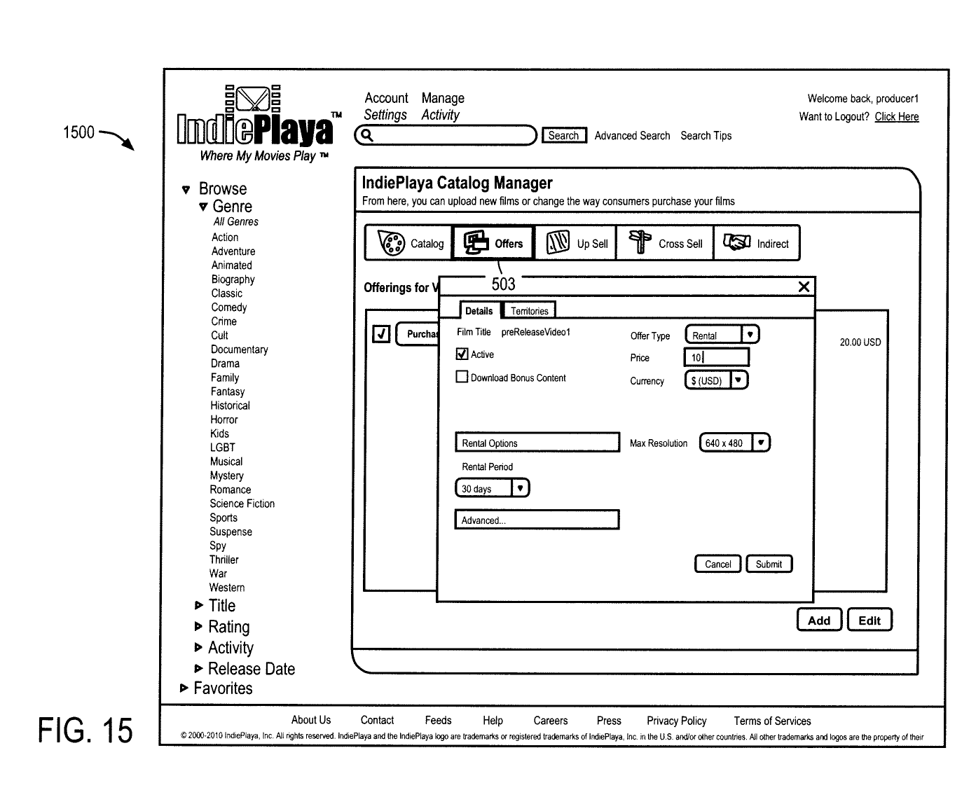

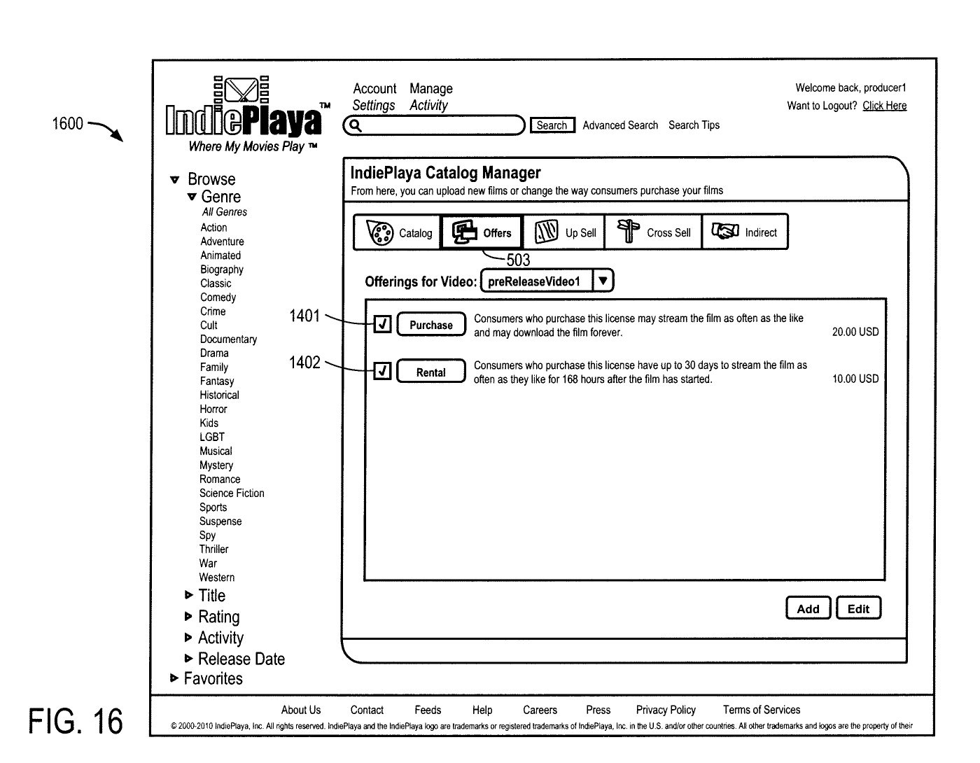

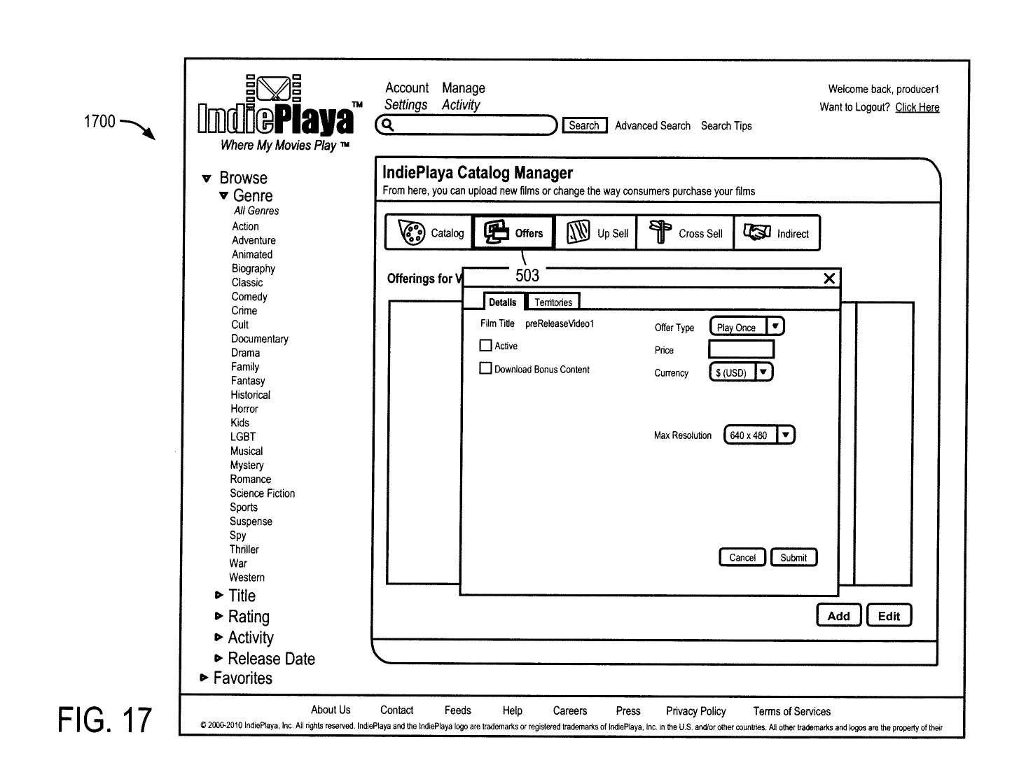

FIG. 15 shows an exemplary interface 1500 for creating an offer (e.g., a rental licensing package). FIG. 16 shows an exemplary interface 1600 for use when interacting with one or more licensing packages. In some implementations, each licensing package can be displayed separately. In some implementations, activation of purchase button 1401 can be tied to rental button 1402 (e.g., selection of purchase button 1401 can deactivate the licensing package associated with a previously selected rental button 1402). In some implementations, each licensing package can be activated and deactivated separately. Thus, in these implementations, purchase button 1401 can be activated and deactivated separately and distinctly from rental button 1402 (e.g., activation of purchase button 1401 can have no effect upon the state of rental button 1402). FIG. 17 shows an exemplary interface 1700 for creating another offer (e.g., a play once licensing package). One of skill in the art will appreciate that the play once licensing package in FIG. 17 is just one example of an n-number of times licensing package, and that the present disclosure fully contemplates an n-number of time licensing package where n is any positive integer.

FIG. 18 shows an exemplary up-sell interface 1800 for creating an up-sell (e.g., an up-sell licensing package) using a control (e.g., the up-sell control 504), within catalog manager 501 (from FIG. 5). In some implementations, an up-sell (e.g., an up-sell licensing package) can be dynamically created (e.g., by a content creator) at any time, and offered as a licensing option (e.g., to a user). In some implementations, interface 1800 can include one or more controls for defining an up-sell licensing package. As noted above, an up-sell can include an ability to up-sell content (e.g., using a licensing package). In these implementations, when a user exhibits an interest in paying a first amount for a limited use license to use content for a predefined time period (e.g., a day), the content creator can dynamically create and offer the user another license option to use the same content at a second amount and for a different period of time (e.g., forever).

Referring to FIG. 18, a content creator can create an up-sell option for any content created and/or offered by the content creator (e.g., source content 1801), as well as an upgrade 1802 to any content created and/or offered by the content creator. Up-sell interface 1800 can include one or more areas for entering data corresponding to the up-sell. For example, up-sell interface 1800 can include any combination of price area 1803 (e.g., for setting an up-sell price), currency area 1804 (e.g., for setting a type of currency for the up-sell), start date 1805 (e.g., for setting a start date for the up-sell offer), end date 1806 (e.g., for setting an end date for the up-sell offer), and active control 1807 (e.g., for indicating whether the up-sell licensing package is active). Once submitted, an up-sell licensing package can be displayed (e.g., to a user). FIG. 19 shows an exemplary interface 1900 for use when interacting with one or more up-sell licensing packages. As noted above, selecting active control 1807 can cause the system to check visual indication 1901 for the up-sell licensing package on interface 1900 (e.g., indicating that the up-sell licensing package is active).

FIG. 20 shows an exemplary cross-sell interface 2000 for creating a cross-sell option (e.g., a cross-sell licensing package), using a control (e.g., cross-sell control 505), within catalog manager 501 (from FIG. 5). In some implementations, a cross-sell option (e.g., a cross-sell licensing package), can be dynamically created (e.g., by a content creator), at any time, and offered as a licensing option (e.g., to a user). In some implementations, interface 2000 can include one or more controls for defining a cross-sell licensing package. As noted above, a cross-sell can include an ability to cross-sell related or unrelated content (e.g., using a licensing package). For example, when a user exhibits an interest in licensing content, the content creator can dynamically create and offer the user another license option for similar content.

Referring to FIG. 20, a content creator can create a cross-sell option for any content. Cross-sell interface 2000 can include one or more areas for entering data corresponding to a cross-sell option. For example, cross-sell interface 2000 can include any combination of start date 2001 (e.g., for setting a start date for the cross-sell offer), end date 2002 (e.g., for setting an end date for the cross-sell offer), and active control 2003 (e.g., for indicating whether the cross-sell licensing package is active). Once submitted, a cross-sell licensing package can be displayed.

FIG. 20A shows an exemplary license cross-sell interface 2010 for creating a cross-sell option. Cross-sell interface 2010 can include one or more areas for entering data corresponding to a cross-sell option. For example, when a user exhibits an interest in licensing content, the content creator can dynamically create and offer the user another license option for similar content. In this example, when a user selects a content rental or purchase option corresponding to first content (e.g., a video), the content creator is notified or otherwise made aware. Once aware, the content creator can dynamically create and offer a content purchase option for similar second content (e.g., if you like A, you can buy B for $3.00).

FIG. 20B shows an exemplary bundle cross-sell interface 2020 for creating a cross-sell option. Cross-sell interface 2020 can include one or more areas for entering data corresponding to a cross-sell option. In yet another example, when a user exhibits an interest in licensing content, the content creator can dynamically create and offer the user an additional licensing bundle for similar content. In this example, when a user selects a page on which content is hosted, the content creator is notified or otherwise made aware. Once aware, the content creator can dynamically create and offer a content purchase option for the content on the current page as well as one or more additional purchase options for the similar content (e.g., if you like A, you can buy A and B together for $10.00), as part of a bundle of content.

FIG. 21 shows an exemplary interface 2100 for use when interacting with one or more cross-sell licensing packages. As noted above, selecting active control 2003 can cause the system to check visual indication 2101 for the cross-sell licensing package on interface 2100 (e.g., indicating that the cross-sell licensing package is active).

FIG. 22 shows an exemplary indirect interface 2000 for creating an insider offer (e.g., a pitch licensing package) using a control (e.g., indirect control 506), within catalog manager 501 (from FIG. 5). In some implementations, an insider offer (e.g., a pitch licensing package), can be dynamically created at any time (e.g., by a content creator), and offered as a licensing option (e.g., to a third party user such as an industry insider). In some implementations, interface 2200 can include one or more controls for defining an insider offer (e.g., a limited ability to promote content without the ability to sell the content). A content creator can create an insider offer for any content. Insider interface 2200 can include one or more areas for entering data corresponding to an insider offer. For example, insider interface 2200 can include pitch area 2201 for indicating one or more terms of a pitch licensing package, and active control 2202 (e.g., for indicating whether the pitch licensing package is active). Once submitted, the pitch licensing package can be displayed.

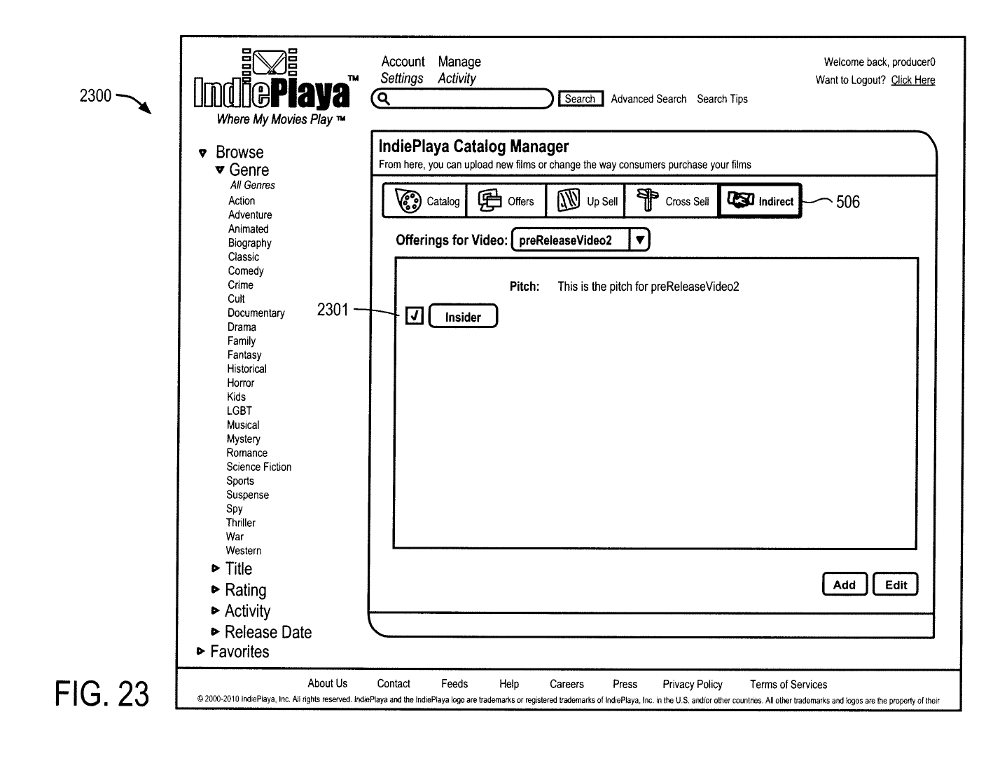

FIG. 23 shows an exemplary interface 2300 for use when interacting with one or more pitch licensing packages. As noted above, selecting the active control 2202 can cause the system to check the visual indication 2301 for the pitch licensing package on interface 2300 (e.g., indicating that the pitch licensing package is active). In some implementations, when a third party (e.g., an influencer or industry insider) indicates an interest in content (e.g., by selecting the content), the content creator can send the industry insider a pitch licensing package. In these implementations, the content creator can be notified of the insider interest (e.g., by the system) and/or discover the insider interest by monitoring the system (e.g., by generating one or more reports).

In some implementations, an insider can be any third party granted the right to perform one or more of the following functions with respect to content and content-related data: processing, marketing, promotion, management, packaging, merchandising, fulfillment, delivery, distribution, licensing, and enforcement of content and/or content-related data. In some implementations, an insider can be considered a content provider.

A content provider is the content creator or any third party granted the right to market or distribute (including, without limitation, subdistribution, syndication, and licensing of) a content creator's content or content-related data or metadata. A content provider can include, but is not limited to, a distributor, subdistributor, broadcaster, syndicator, assignee, and licensee of content and/or content-related data. In some implementations, a content provider can perform any and all functions associated with the systems and methods provided herein.

It should be understood that any and all functions performed by a content creator can also be performed by a content provider.

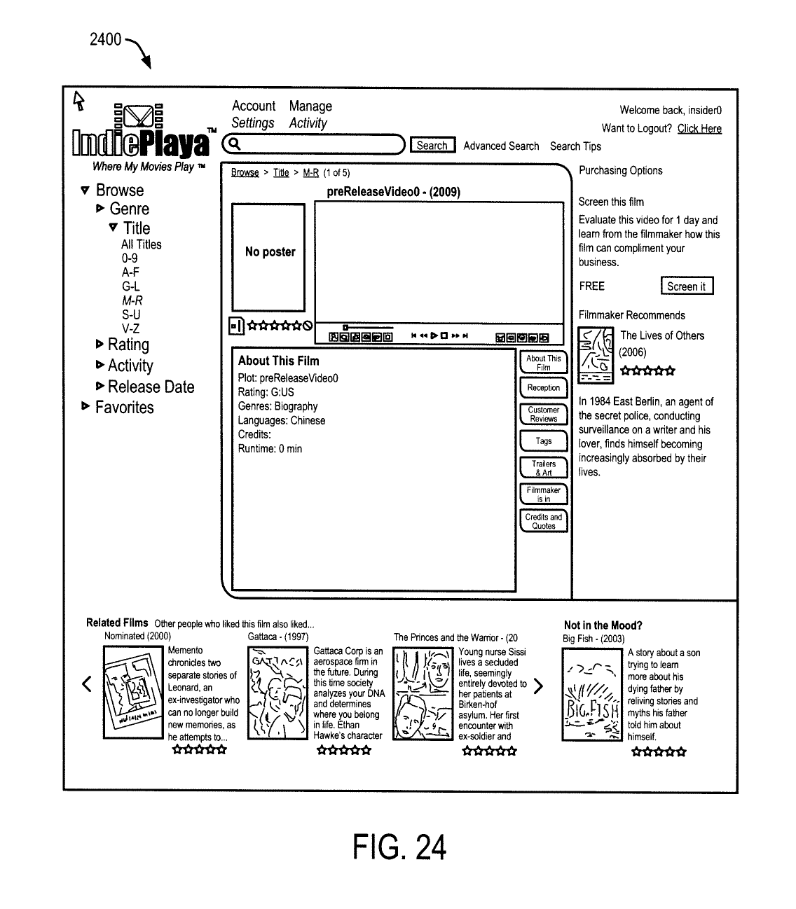

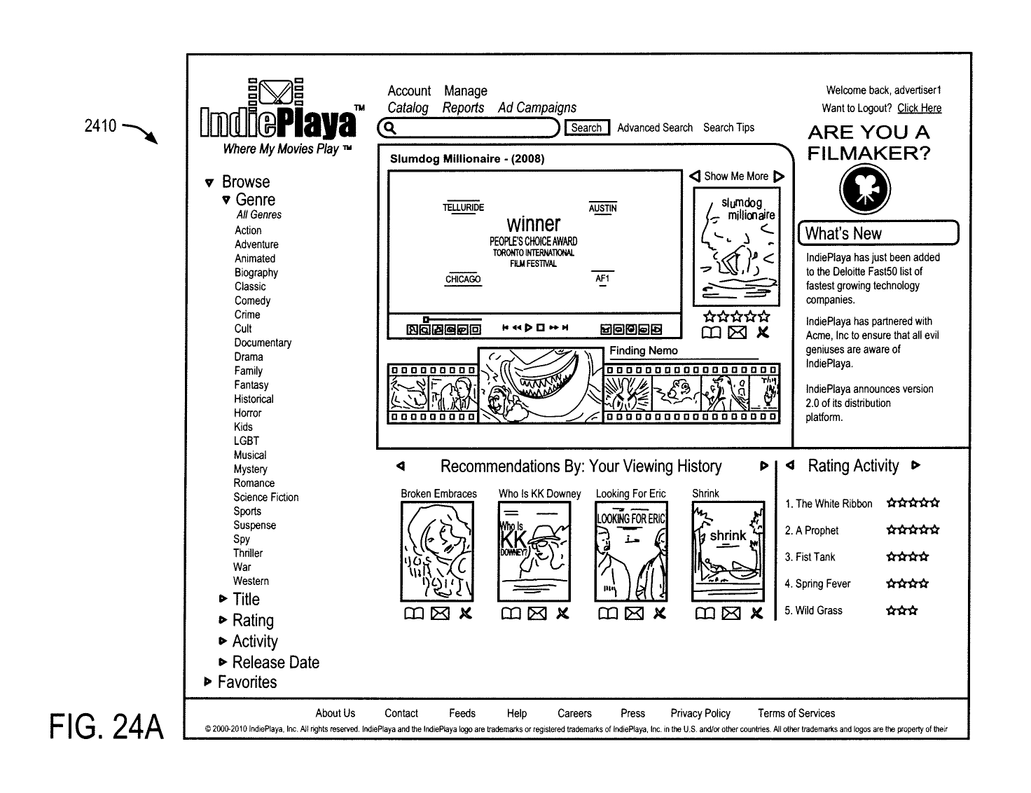

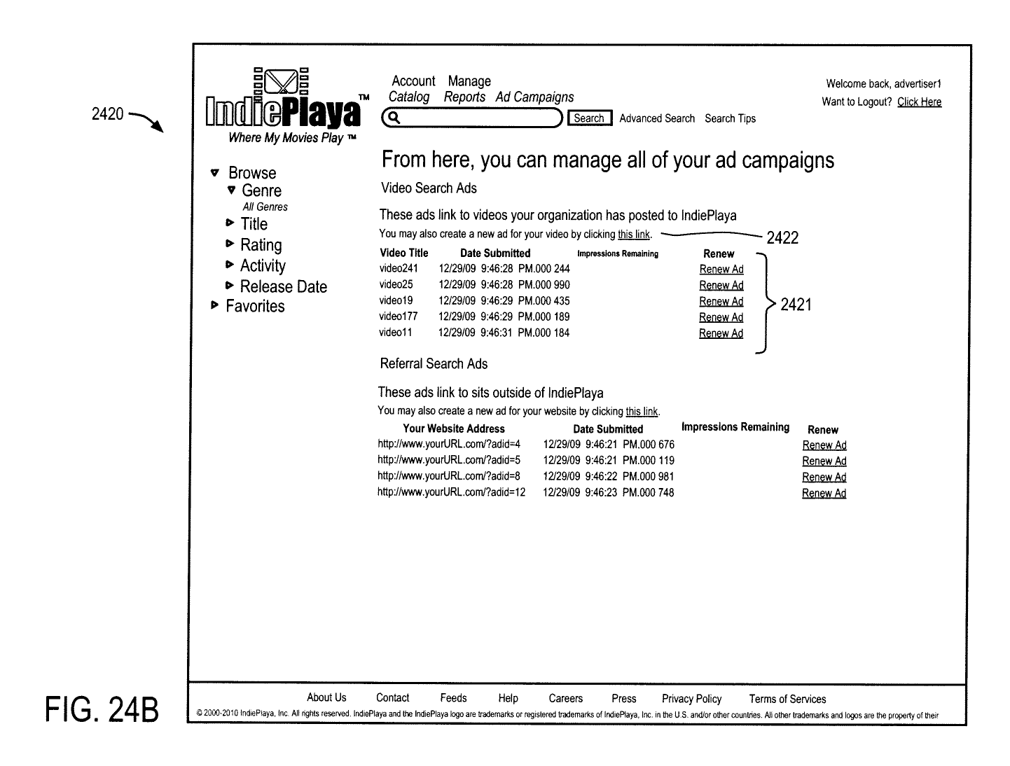

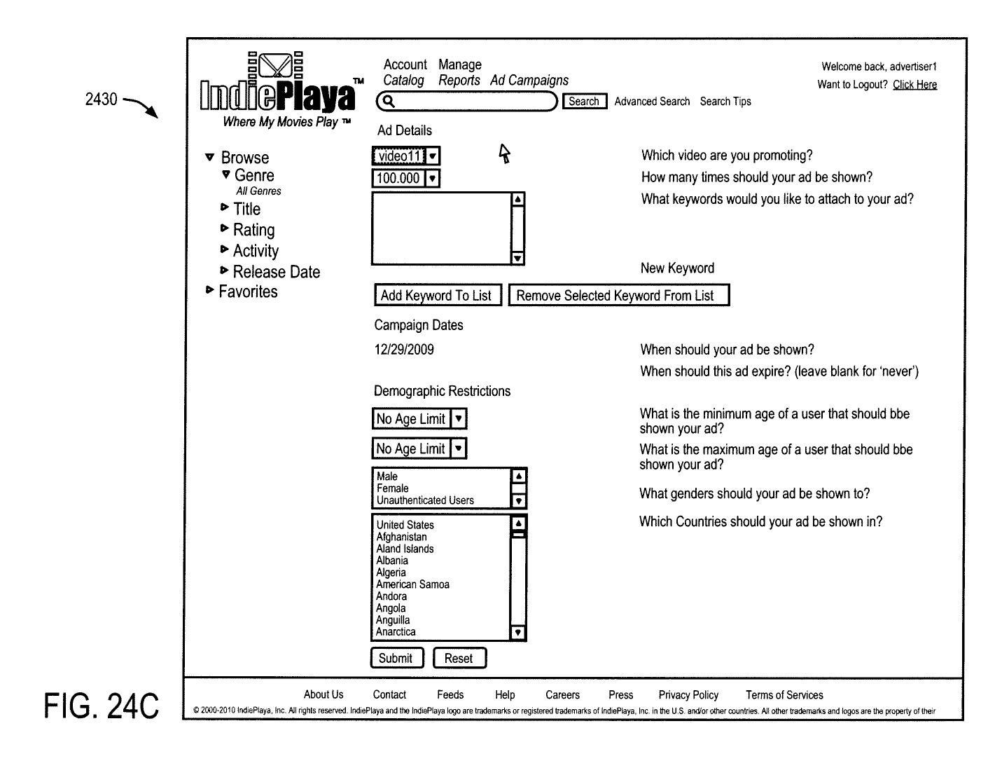

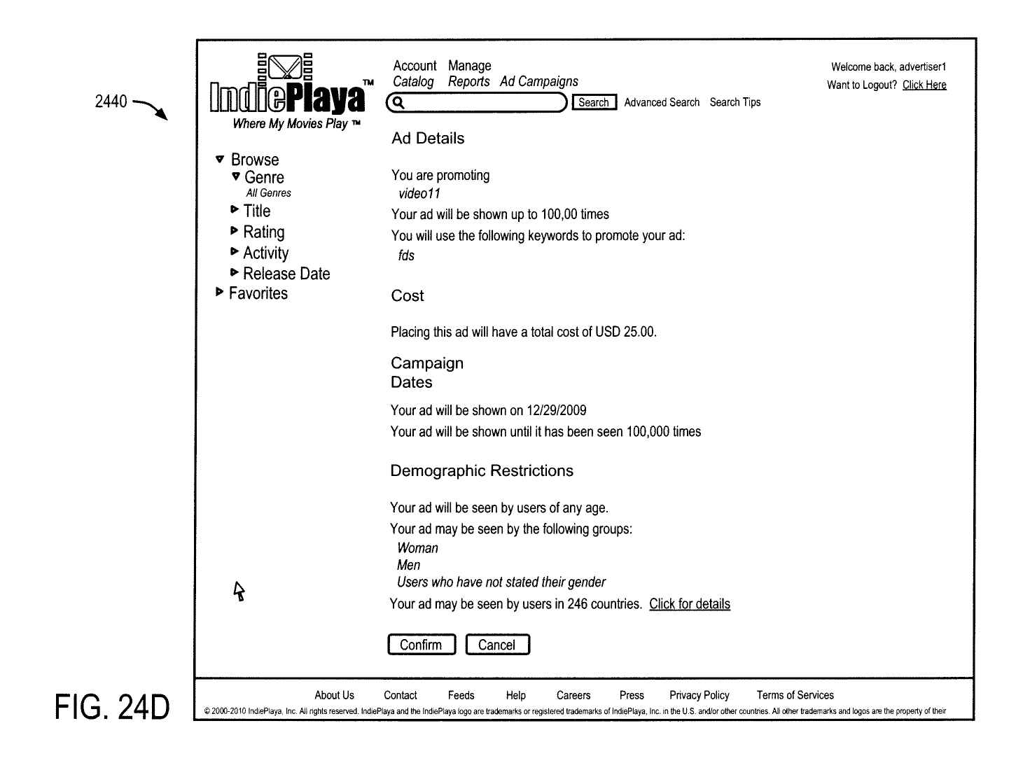

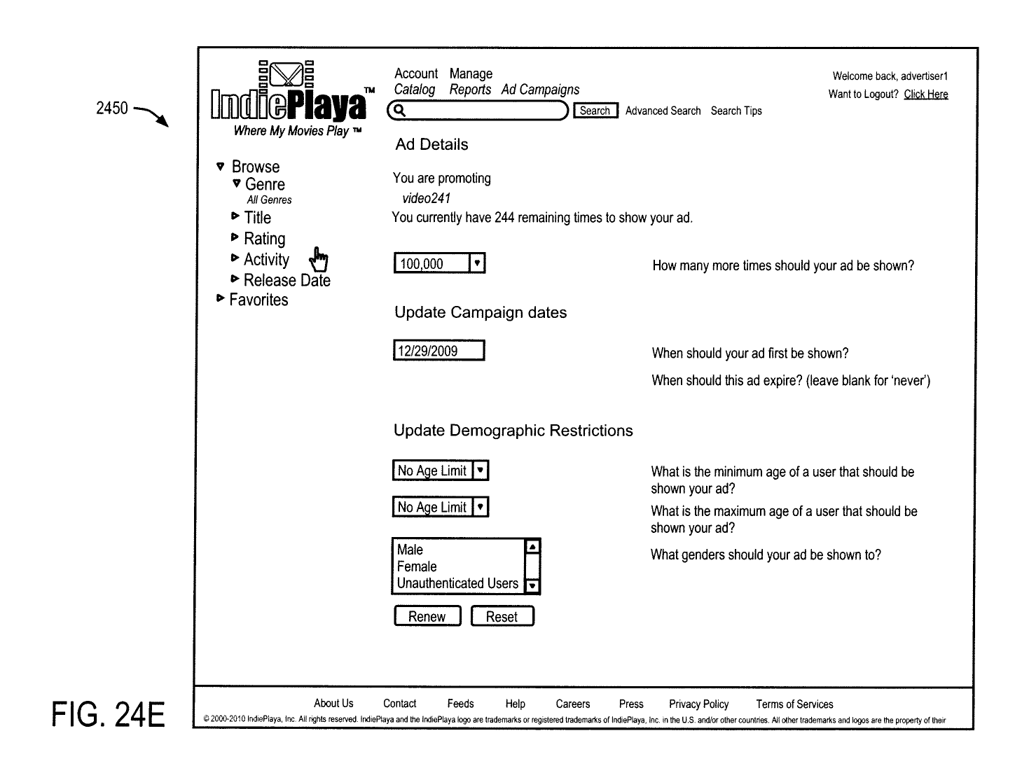

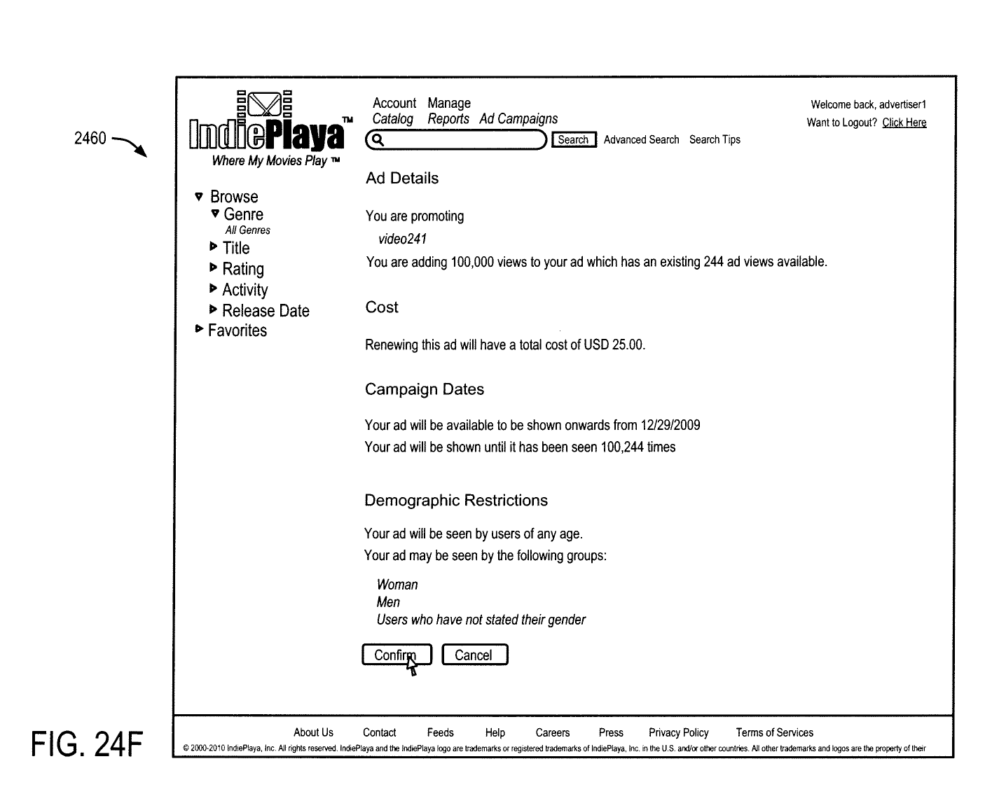

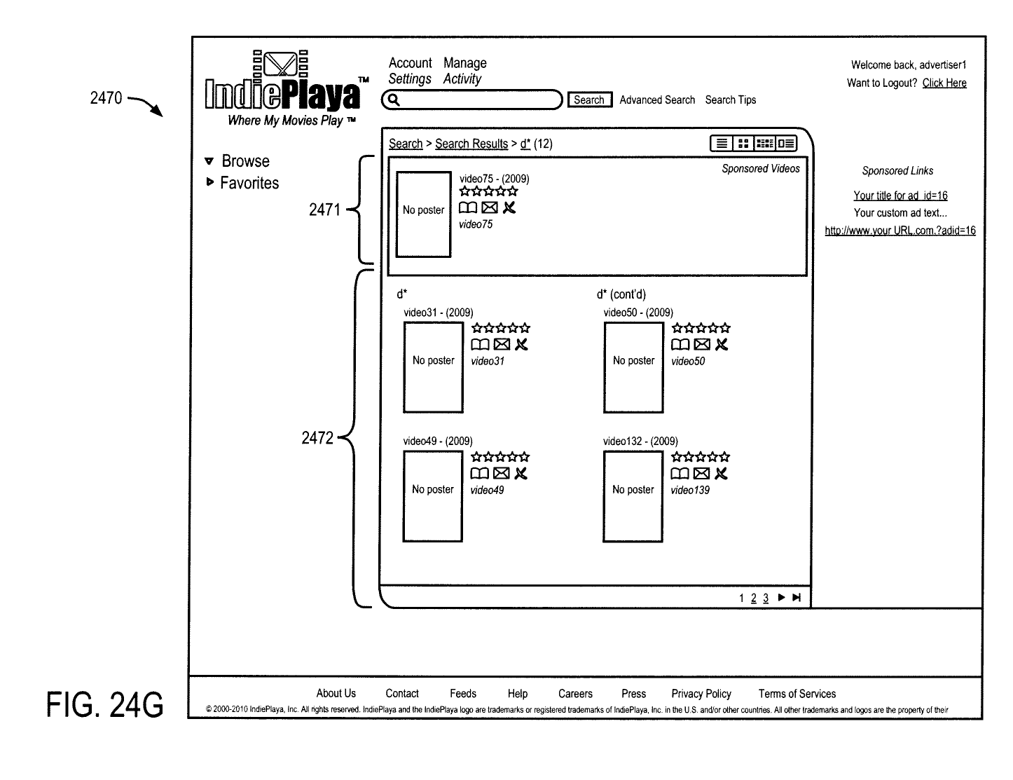

In some implementations, an insider interest functionality allows the insider to limit the number of pitch licensing packages they receive (e.g., packages are only sent when interest is expressly indicated). Additionally, content creators are able to monitor insider interest. For example, when an insider indicates interest in content, the content creator can run a report to see whether additional different insider interest exists. If the report is indicative of additional different insider interest, the content creator can choose to negotiate with the insider. If the report is indicative of no additional insider interest, the content creator can choose to accept an insider offer without further negotiation. FIG. 24 shows an exemplary interface 2400 for use by an industry insider (e.g., a third party promoter or influencer). Using the interface 2400, an industry insider can indicate interest in, view, and express an interest in licensing content.

In some implementations, when a party (e.g., a content creator or a third party), indicates an interest in promoting content (e.g., using an ad campaign), the system can generate one or more content-related advertisements. FIGS. 24A-24G show exemplary interfaces for interacting with content to create, renew, generate, and/or display content-related advertisements. FIG. 24A shows example interface 2410 for use by a party (e.g., a content creator or a third party). FIG. 24B shows exemplary interface 2420 including a list of renewable content-related advertisements 2421 and a link 2422 to facilitate creation of new renewable content-related advertisements. FIG. 24C shows an exemplary interface 2430 including one or more areas for entering content-related data. Using exemplary interface 2430, a party (e.g., a content creator or a third party), can generate one or more content-related advertisements. FIG. 24D shows an example interface 2440 including a summary of a new content-related advertisement corresponding to the content-related data entered in FIG. 24C. Using example interface 2440, a party (e.g., a content creator or a third party), can confirm or cancel a new content-related advertisement. In some implementations, when a new content-related advertisement is confirmed, the system can generate a payment screen to facilitate payment.

FIG. 24E shows an exemplary interface 2450 including one or more areas for entering content-related data. Using exemplary interface 2450, a party (e.g., a content creator or a third party), can renew one or more existing content-related advertisements. FIG. 24F shows an exemplary interface 2460 including a renewal summary of the content-related advertisement corresponding to the content-related data entered in FIG. 24E. Using exemplary interface 2460, a party (e.g., a content creator or a third party), can confirm or cancel the renewal of a content-related advertisement. In some implementations, when the renewal of a content-related advertisement is confirmed, the system can generate a payment screen to facilitate payment.

FIG. 24G shows an exemplary interface 2470 of search results (e.g., based upon a search that incorporates one or more advertisement keywords). Exemplary interface 2470 can be viewed by any user (e.g., audience member), using the system. Exemplary interface 2470 can include a graphical depiction of content 2471 (e.g., the promoted video content), corresponding to a content-related advertisement and one or more content-related advertisement keywords. Additionally, exemplary interface 2470 can also include a graphical depiction of search results 2472 (e.g., content that corresponds to the search that incorporates the one or more content-related advertisement keywords).

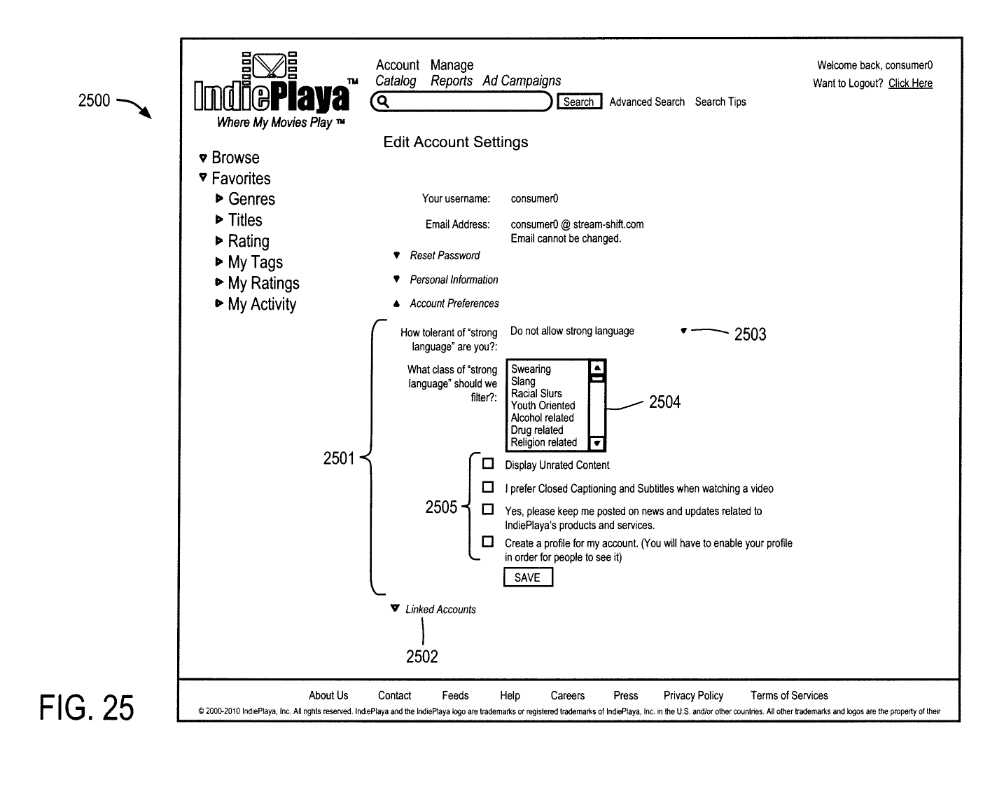

FIG. 25 shows an exemplary interface 2500 for setting and editing user (e.g., audience member), account settings. Interface 2500 can include one or more areas for entering user account information such as a unique challenge (e.g., a user name and a password), and any other personal information requested or required by the system. Interface 2500 can also include an account preferences area 2501 for setting one or more user account preferences such as tolerance for strong language setting 2503, strong language classification filter 2504, and other account preference options 2505 (e.g., display unrated content, closed captioning, product and service updates, and profile creation). Additionally, interface 2500 can also include linked accounts area 2502 for indicating related accounts (e.g., social networking accounts), and facilitating connection to related accounts.

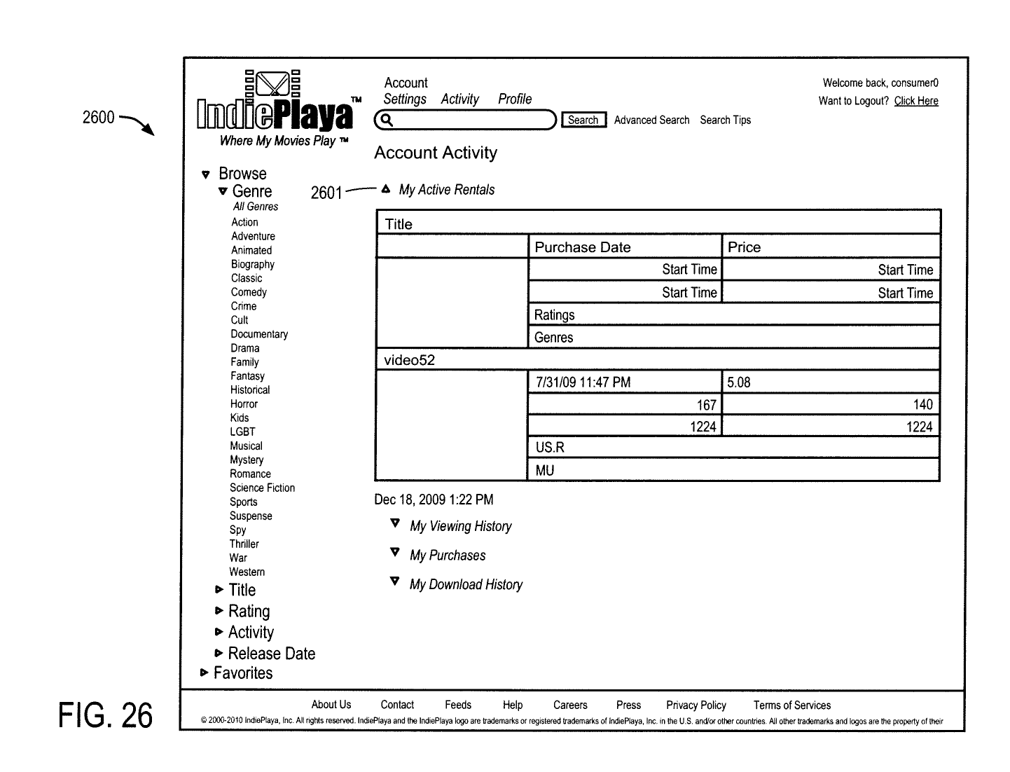

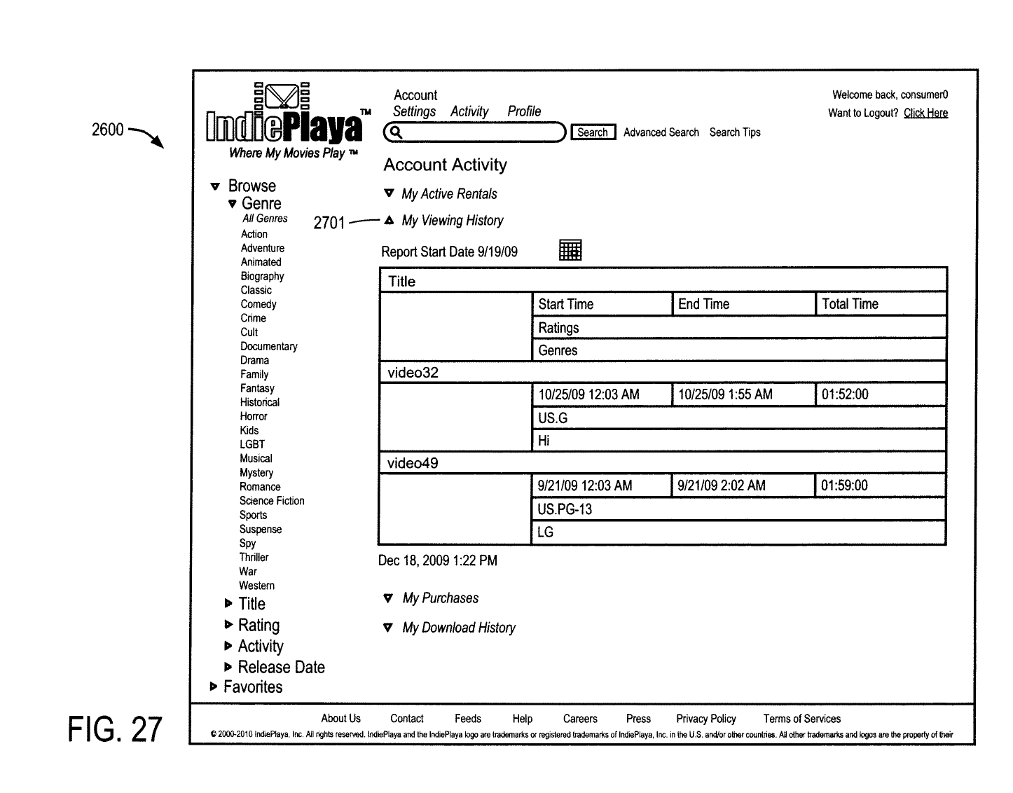

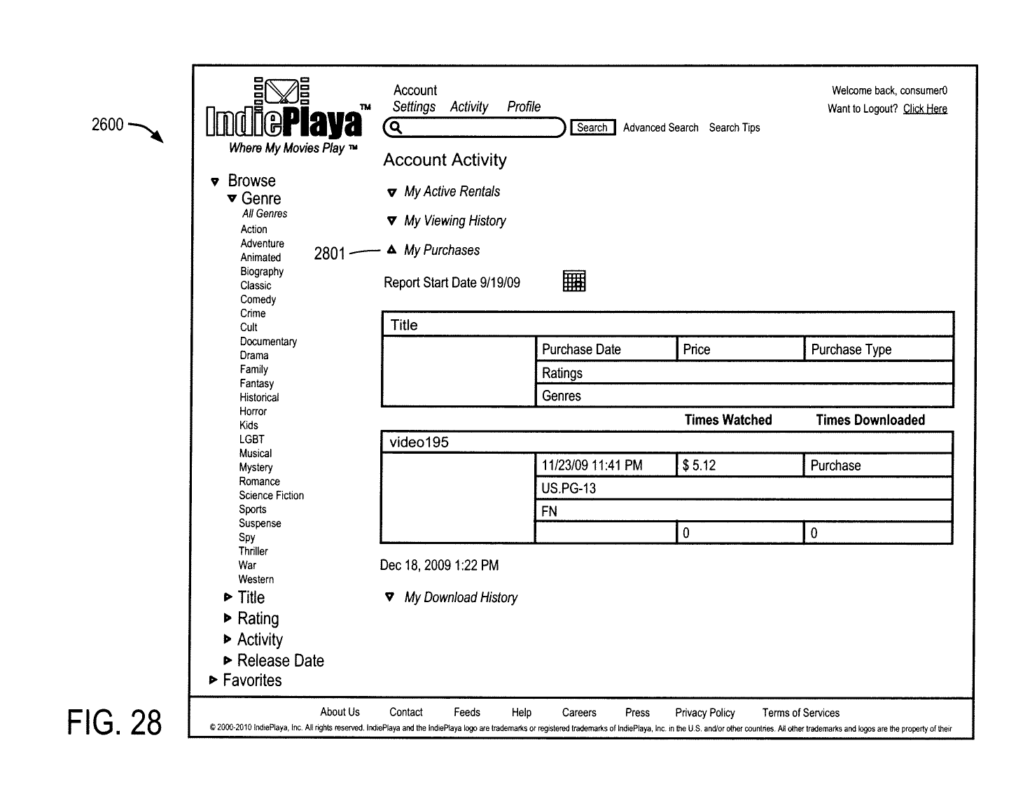

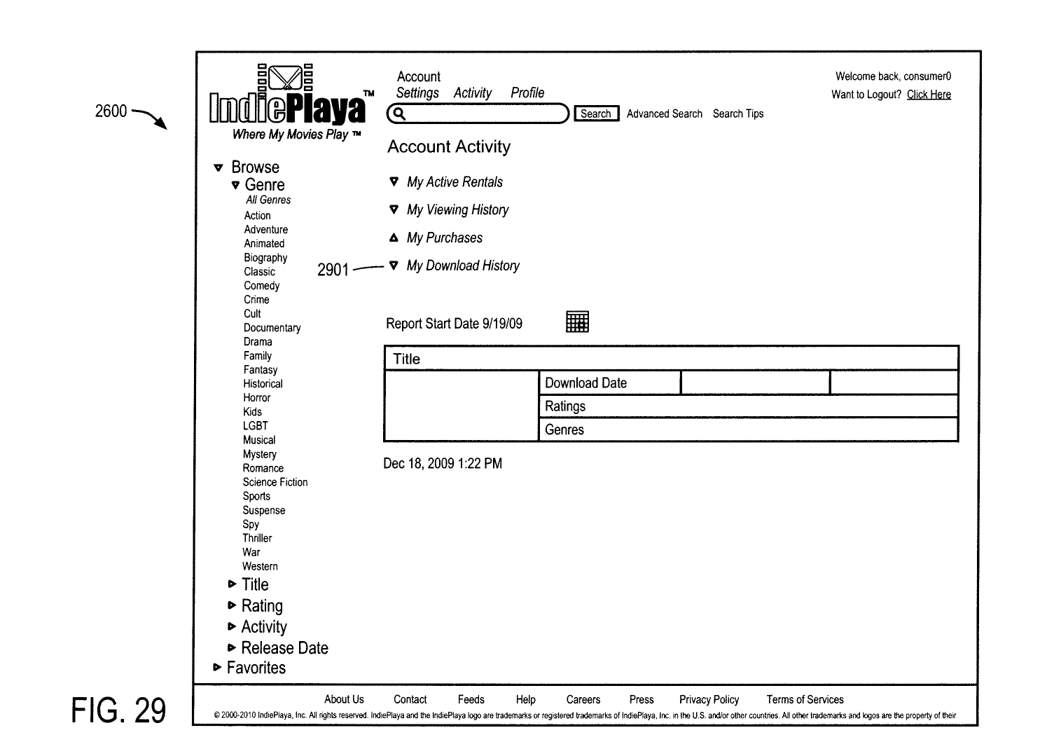

FIG. 26 shows an exemplary interface 2600 for viewing account activity (e.g., active rentals, viewing history, purchases, or download history). Interface 2600 can include expandable active rental area 2601 for viewing information corresponding to currently active rentals. FIG. 27 also shows exemplary interface 2600 for viewing account activity. Interface 2600 can also include an expandable viewing history area 2701 for viewing information corresponding to a user viewing history. FIG. 28 also shows exemplary interface 2600 for viewing account activity. Interface 2600 can also include an expandable my purchases area 2801 for viewing information corresponding to the user purchases. FIG. 29 also shows exemplary interface 2600 for viewing account activity. Interface 2600 can also include an expandable “my download” history area 2901 for viewing information corresponding to a user download history.

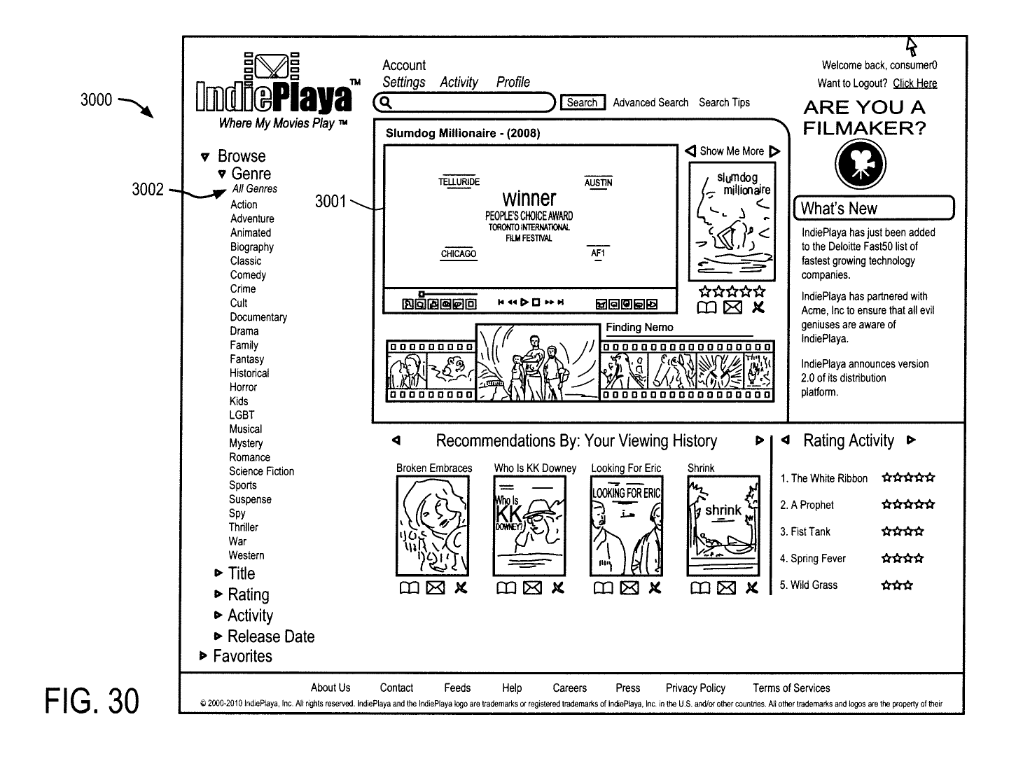

FIG. 30 shows an exemplary interface 3000 for use by a user (e.g., an audience member), when interacting with the system. Using the interface 3000, a user can interact with content. For example, interface 3000 can include a viewing area 3001 (e.g., a window), for interacting with (e.g., viewing), content. In some implementations, as noted above, content can be categorized statically (e.g., by the user), or dynamically (e.g., manually by the user or automatically by the system). In these implementations, a user can browse categorized content (e.g., by genre or by popularity).

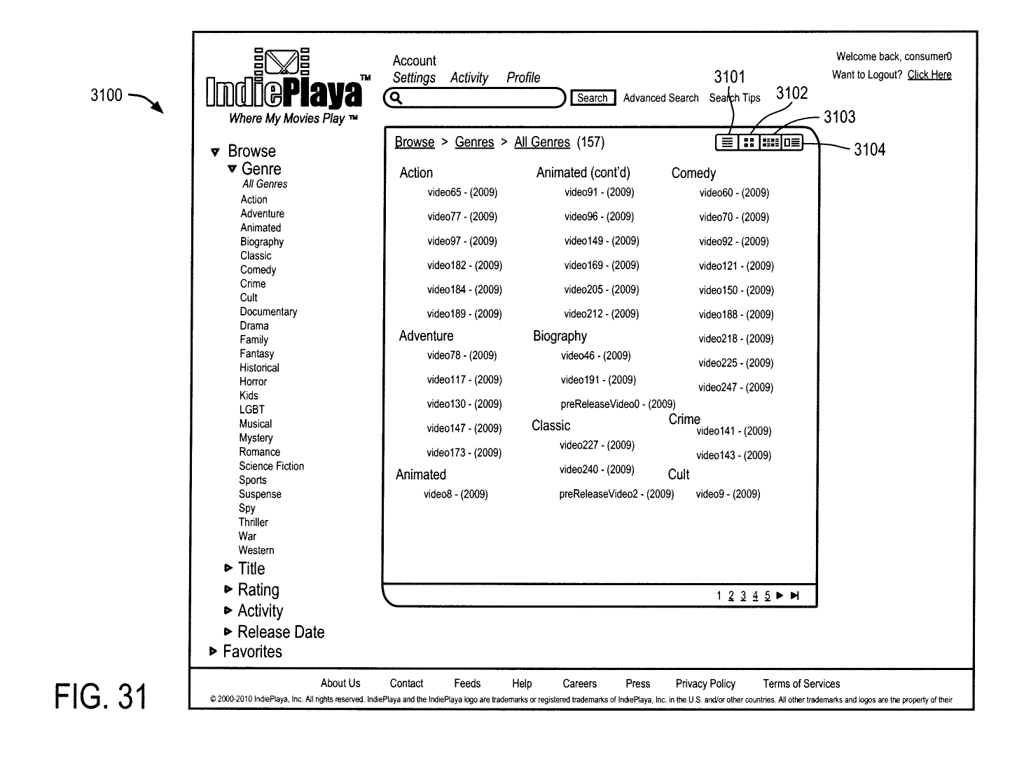

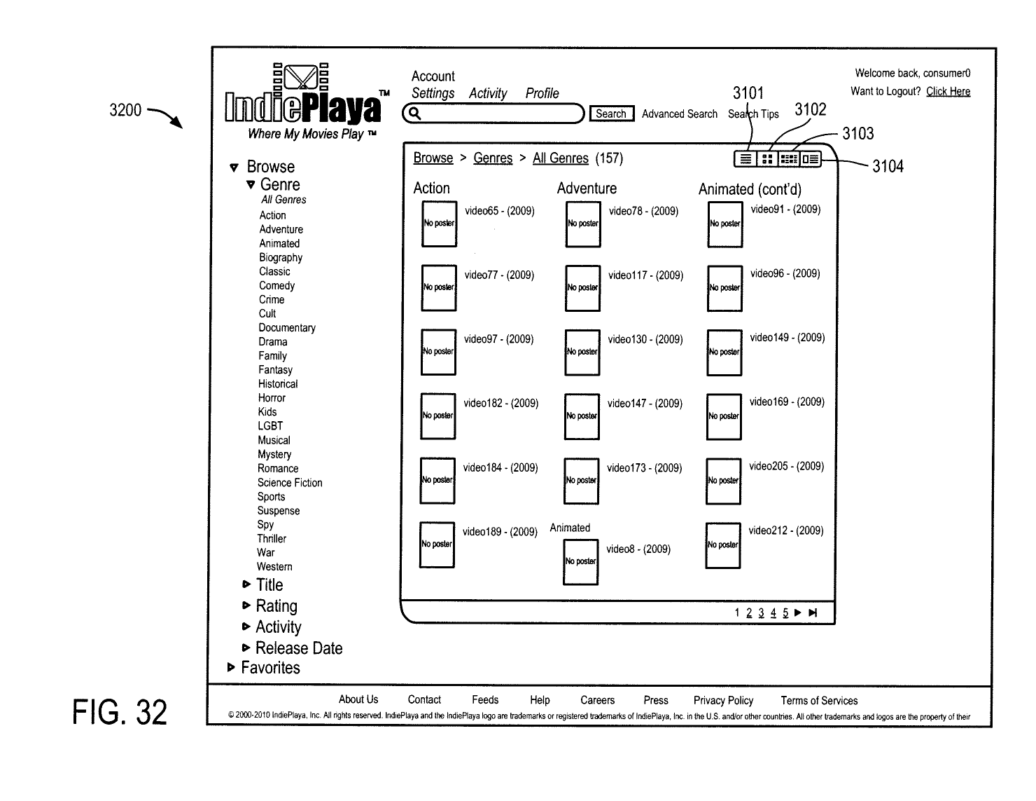

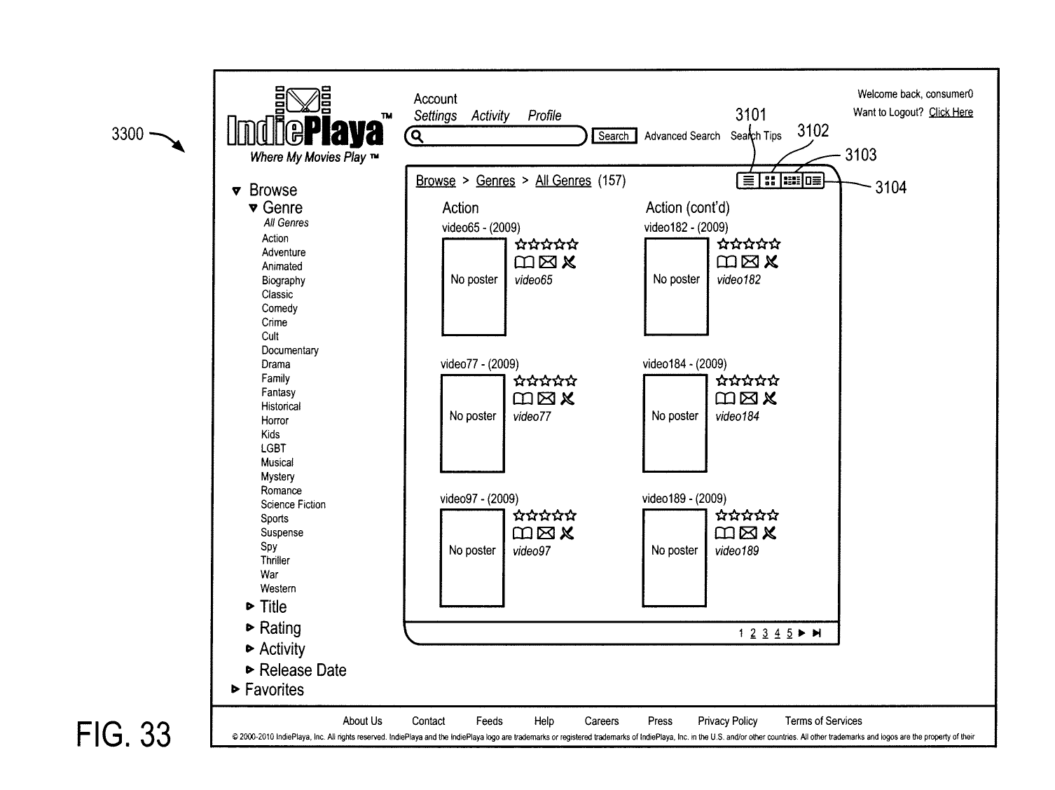

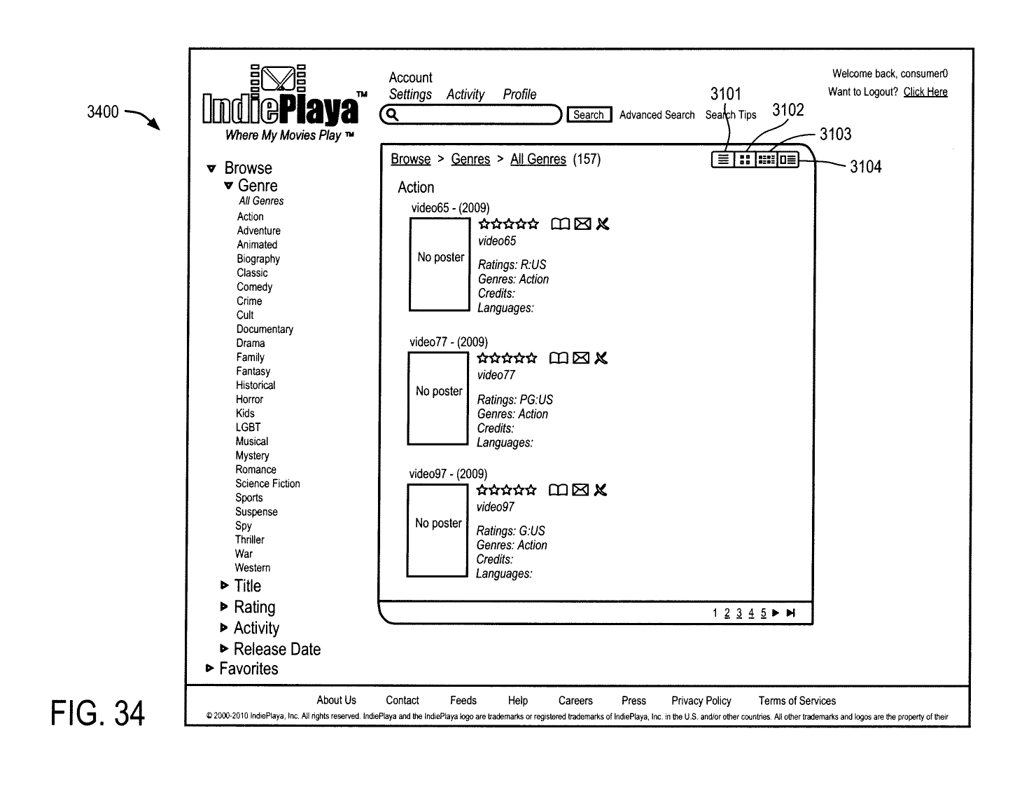

FIGS. 31-34 show exemplary interfaces for browsing content. FIG. 31 shows an exemplary interface 3100 for browsing content. Interface 3100 can include one or more example controls 3101, 3102, 3103, and 3104 for changing content perspective (e.g., zooming in (drilling down) on content and zooming out (drilling up) on content). Interface 3100 includes a depiction of content from the perspective associated with example control 3101. Selecting another exemplary control can provide the user with a different perspective of the content. FIG. 32 shows an exemplary interface 3200 including a depiction of content from the perspective associated with example control 3102. FIG. 33 shows an exemplary interface 3300 including a depiction of content from the perspective associated with example control 3103. FIG. 34 shows an exemplary interface 3400 including a depiction of content from the perspective associated with example control 3104.

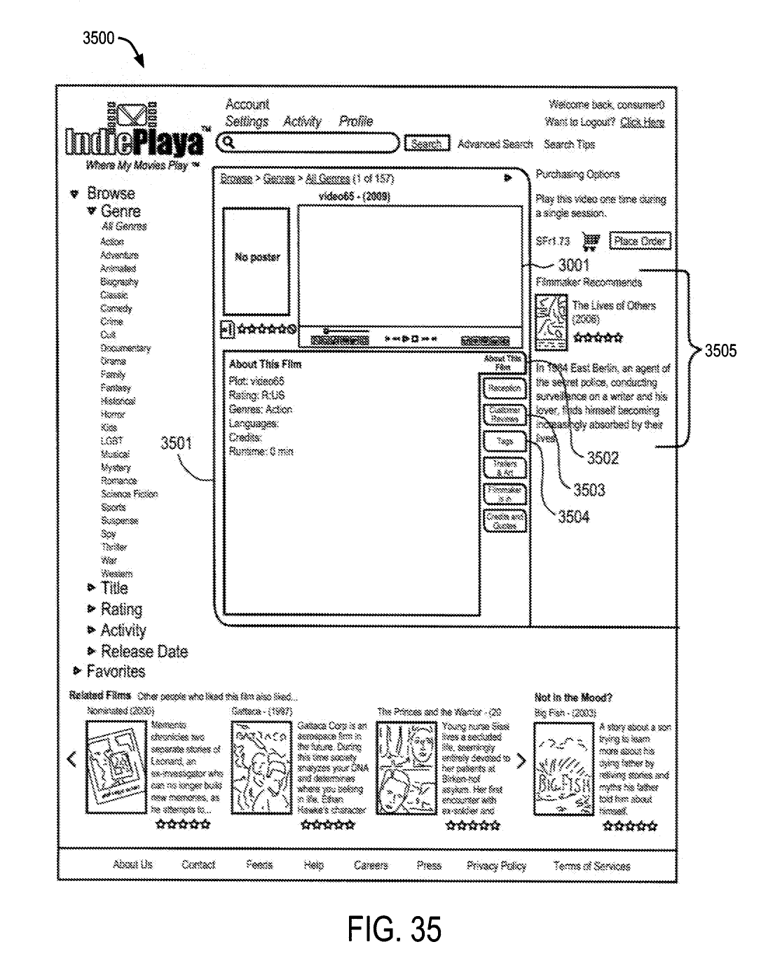

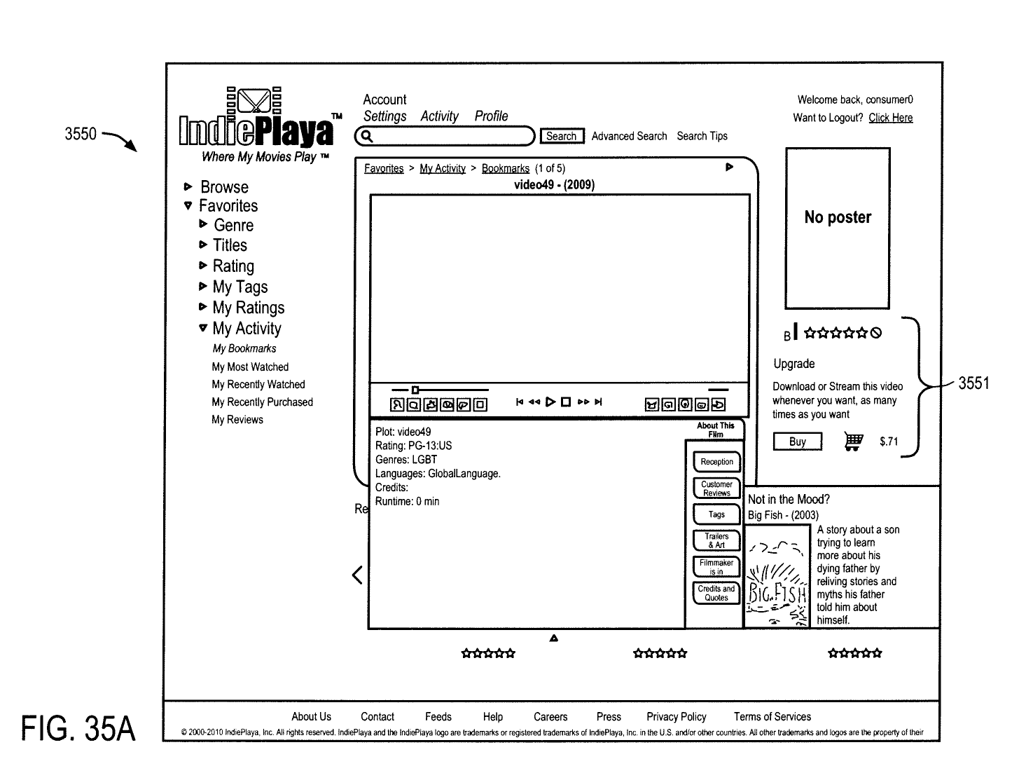

FIGS. 35-39 show exemplary interfaces for interacting with content. FIG. 35 shows an exemplary interface 3500 that is an expanded version of interface 3000 (shown in FIG. 30) for use by a user (e.g., an audience member) when interacting with the system. Specifically, interface 3000 (from FIG. 30), can be expanded into a fixed interface 3500 showing additional controls 3502, 3503, and 3504 that can be used to interact with content. For example, interacting with an “about this” control 3502 (e.g., an “about this film” control), can cause the system to generate and display data corresponding to content (e.g., content displayed in viewing area 3001), in expanded viewing area 3501. In some implementations, interface 3500 can also include one or more content recommendations 3505. In some implementations, one or more licensing packages noted above (e.g., an up-sell) can be manually (e.g., by a content creator), or dynamically (e.g., by the system) generated and displayed to a user. FIG. 35A shows an exemplary interface 3550 including a licensing package upgrade option 3551 (e.g., an unlimited content download for a purchase price of $71). Additionally, FIG. 35A includes a larger interface 3000 (from FIG. 30), and a dynamically expanded area that can contain catalog and editorial information that becomes available after a user has purchased content. In some implementations, selecting the licensing package 3551 can cause the system to end any other licensing package (e.g., a limited rental), corresponding to the same content.

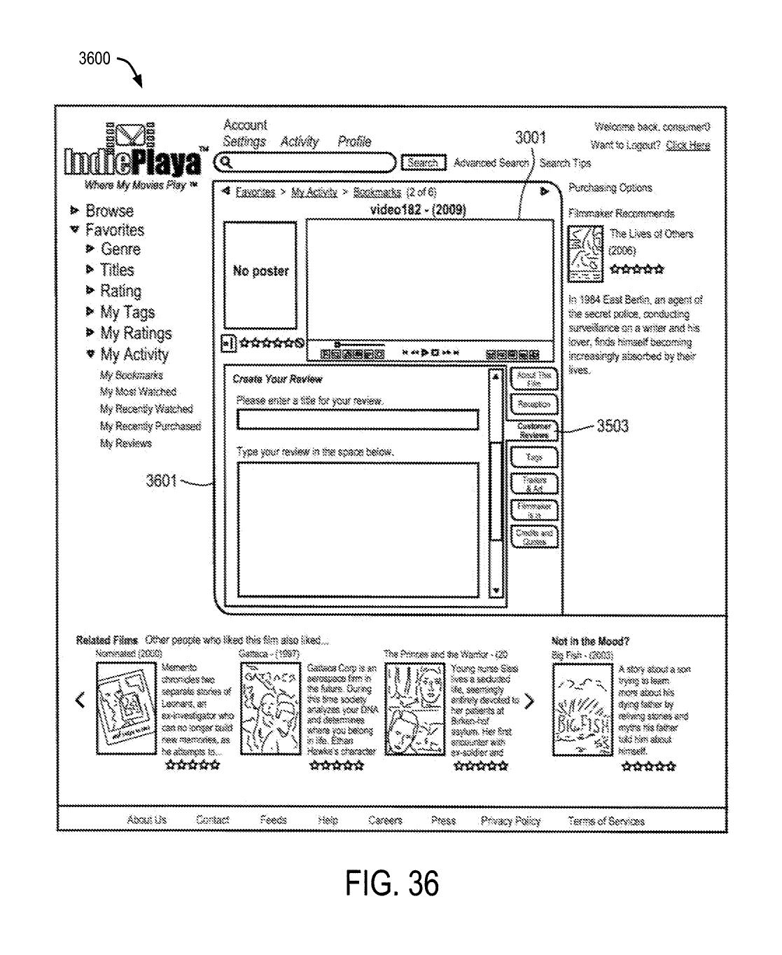

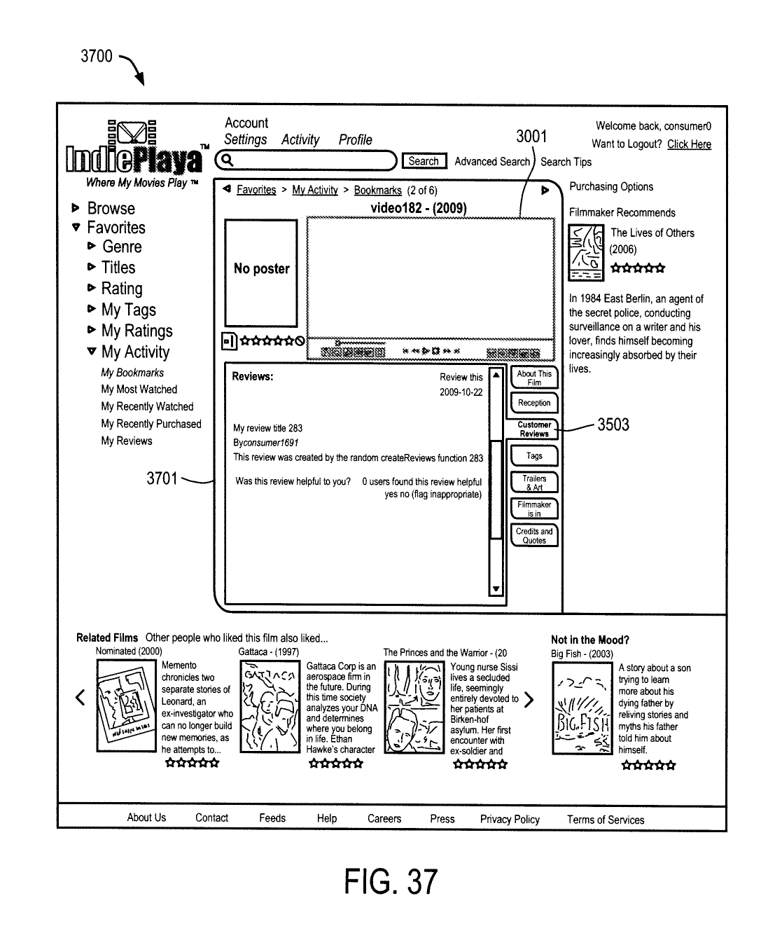

FIG. 36 shows an exemplary interface 3600 including additional “reviews” control 3503 (e.g., a “customer reviews” control). Interacting with reviews control 3503 can cause the system to generate and display one or more areas in which a user (e.g., a customer) can enter data corresponding to a review of content (e.g., content displayed in viewing area 3001), in expanded viewing area 3601. Review data can be displayed (e.g., in accordance with manage profanities area 1202 noted in FIG. 12 above). For example, reviews can be edited automatically by the system to comply with graphic language area 1203, and types of language to restrict area 1204 in manage profanities area 1202 (e.g., noted above in FIG. 12). FIG. 37 shows an exemplary interface 3700 displaying review data in expanded viewing area 3701.

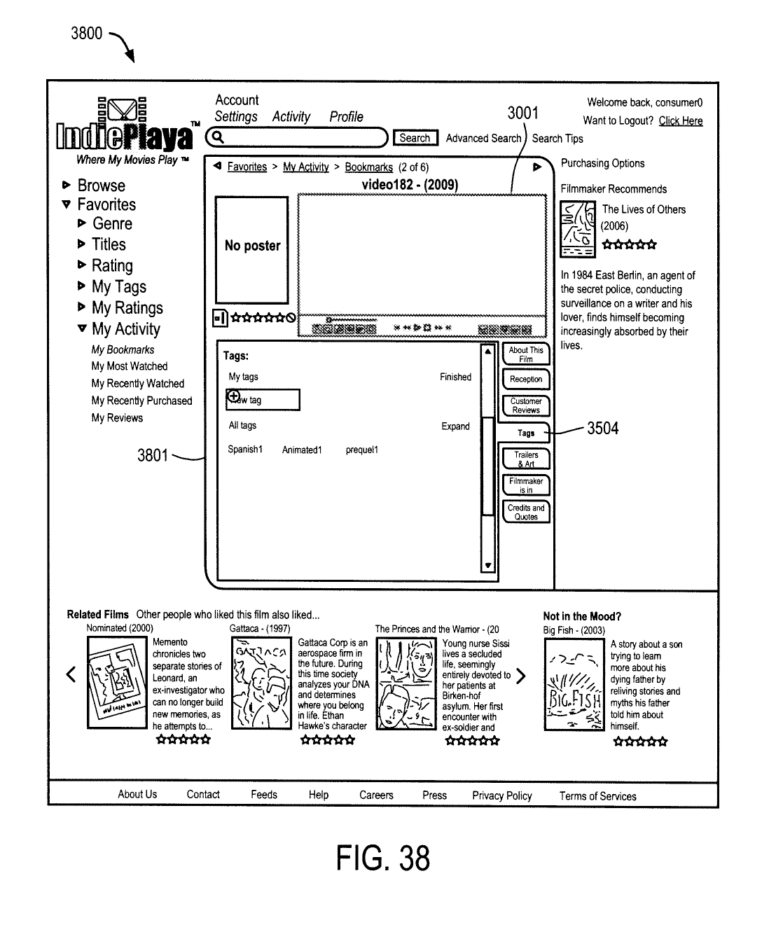

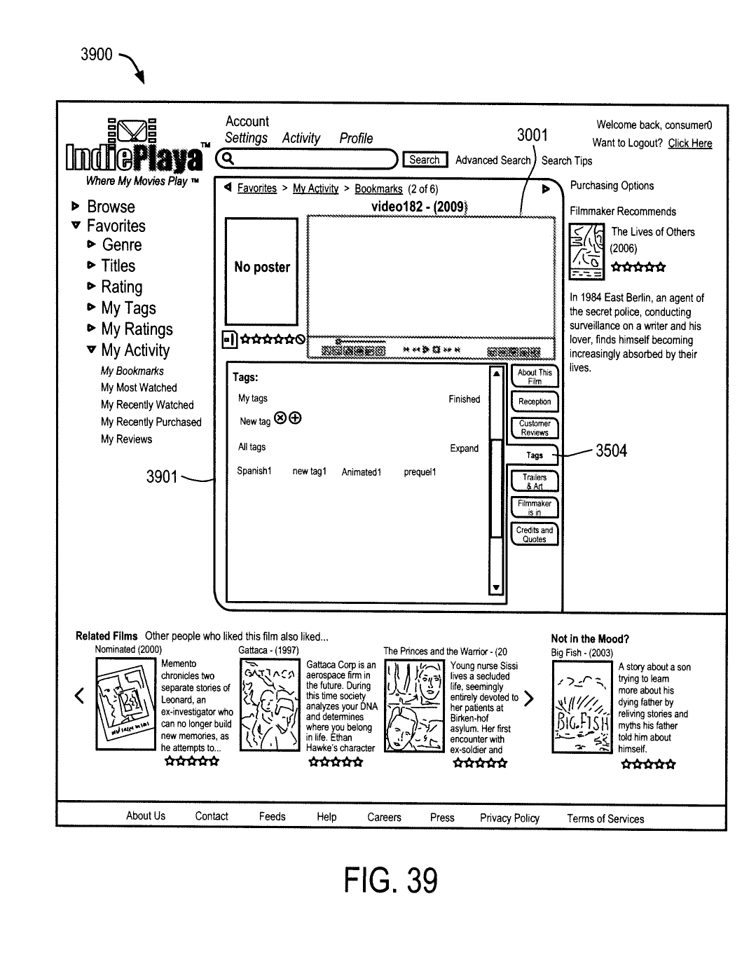

FIG. 38 shows an exemplary interface 3800 including additional “tags” control 3504. Interacting with the tags control 3504 can cause the system to generate and display one or more areas in which a user (e.g., a customer) can enter tag data corresponding to a content tag (e.g., a tag corresponding to and used to search for content displayed in viewing area 3001), in expanded viewing area 3801. Tag data can be displayed (e.g., in accordance with manage profanities area 1202 noted above). In some implementations, tags can be edited automatically by the system to comply with graphic language area 1203, and types of language to restrict area 1204 in manage profanities area 1202. FIG. 39 shows an exemplary interface 3900 displaying tag data in expanded viewing area 3901.

In some implementations, as noted with respect to FIG. 3 above, intelligence 305 can be processed and statistics can be automatically generated (e.g., in real-time), based upon website activity (e.g., audience 306 interaction). Generated statistics can be used (e.g., by the system) to generate one or more reports (e.g., based upon audience 306 interaction). For example, reports can be used by a content creator to examine account histories and to make one or more content recommendations or offers (e.g., licensing packages). Additionally, content recommendations or offers can be made available for a single account or for a group of related accounts.

Reports can be generated according to one or more parameters such as report type, report demographic, and report dimension. Report types can include, but are not limited to business activity and site activity.

In some implementations, site activity can denote the collection of site wide aggregations of system activity which contains raw and processed statistics, data and metadata for all content creators and all content associated with the system. In these implementations, content creators can use the site activity data to generate reports based on collected, synthesized and aggregated content and content-related data and metadata in order to analyze the aggregate activity of all content for all content creators associated with the system or some subset of this data as requested in the report filters, settings and parameters.

In some implementations, business activity can denote the collection of aggregations of activity related to the content creator's content which contains raw and processed statistics, data and metadata for the content creator and all content associated with the content creator. In these implementations, the content creator can use the business activity data to generate reports based on collected, synthesized and aggregated content and content-related data and metadata in order to analyze the activity of all content associated with the content creator or some subset of this data as requested in the report filters, settings and parameters.

In some implementations, business activity and site activity can be further categorized. For example, business activity can be categorized by revenues, purchases, impressions, streams, downloads, bookmarks, ratings, reviews, tags, insider interactions, video search click-throughs, video search ad click-throughs, video search ad impressions, and referral search ad impressions. Site activity, for example, can be categorized by visitors, logins, registrations, revenues, purchases, impressions, streams, downloads, bookmarks, ratings, reviews, tags, insider interactions, video search click-throughs, video search ad click-throughs, video search ad impressions, and referral search ad impressions.

FIGS. 40-49 show exemplary interfaces for interacting with content to generate and display reports. FIG. 40 shows exemplary interface 4000 including an example activity report. In some implementations, an example activity report can include one or more selectable options for specifying content selection and for generating one or more graphic interpretations (e.g., scatter plot, pie chart, bar chart, etc.), of the selected content. In this example, an activity report has been generated based upon the report demographic 4001. Report demographic 4001 can include selectable region 4002 that can list one or more selectable report demographic options such as country, gender, or age. In this example, an activity report has been generated based upon a selection 4002 of report demographic 4001 country. Additionally, a selection 4002 of a report demographic 4001 country can cause the system to generate one or more additional options (e.g., dropdown menu 4003), for specifying content selection by country. Example interface 4000 also includes a graphic interpretation 4004 of the selected content.

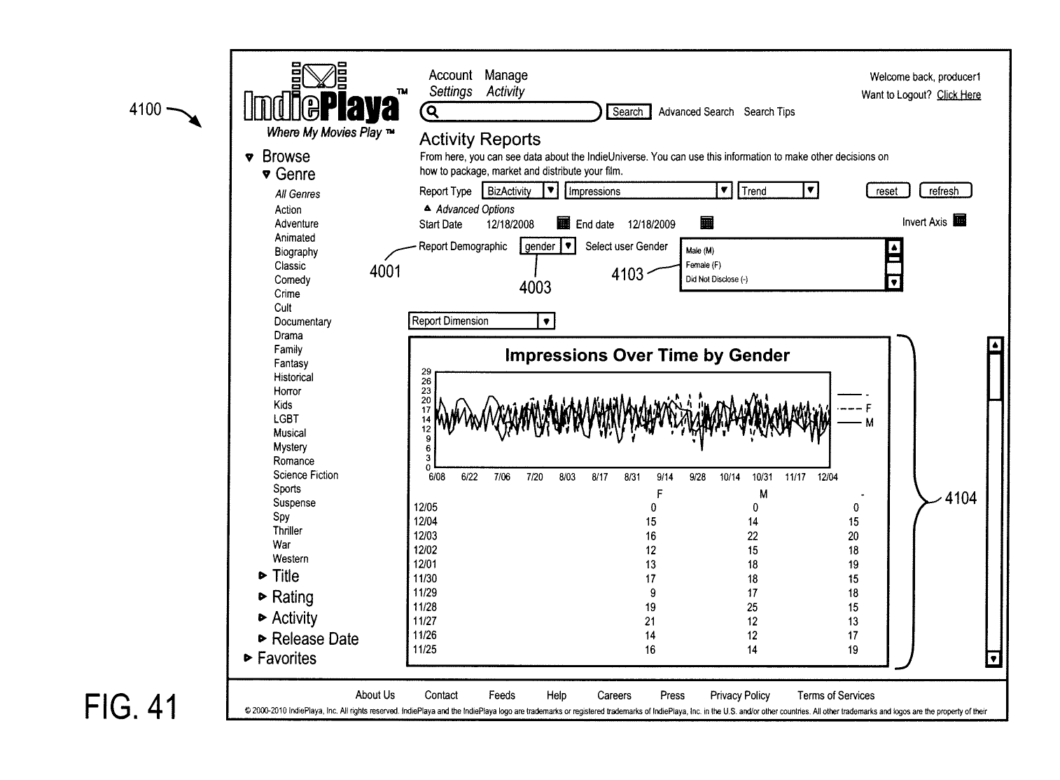

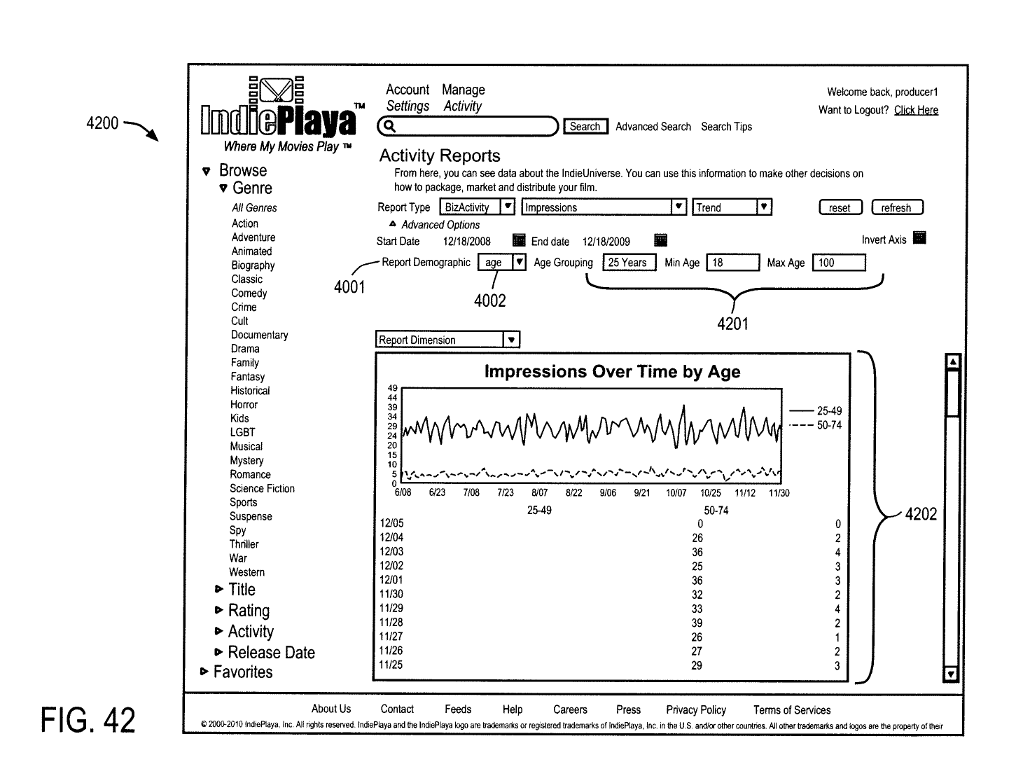

FIG. 41 shows an exemplary interface 4100 including another exemplary activity report. In this example, an activity report has been generated based upon a selection 4002 of the report demographic 4001 “gender”. Additionally, a selection 4002 of a report demographic 4001 can cause the system to generate one or more additional options (e.g., dropdown menu 4103), for specifying content selection by gender. Exemplary interface 4100 also includes a graphic interpretation 4104 of the selected content. FIG. 42 shows an exemplary interface 4200 including another exemplary activity report. In this example, an activity report has been generated based upon a selection 4002 of a report demographic 4001 age. Additionally, a selection 4002 of a report demographic 4001 can cause the system to generate one or more additional options (e.g., options area 4201), for specifying content selection by age (e.g., age grouping, maximum age, or minimum age). Exemplary interface 4200 also includes a graphic interpretation 4202 of the selected content.

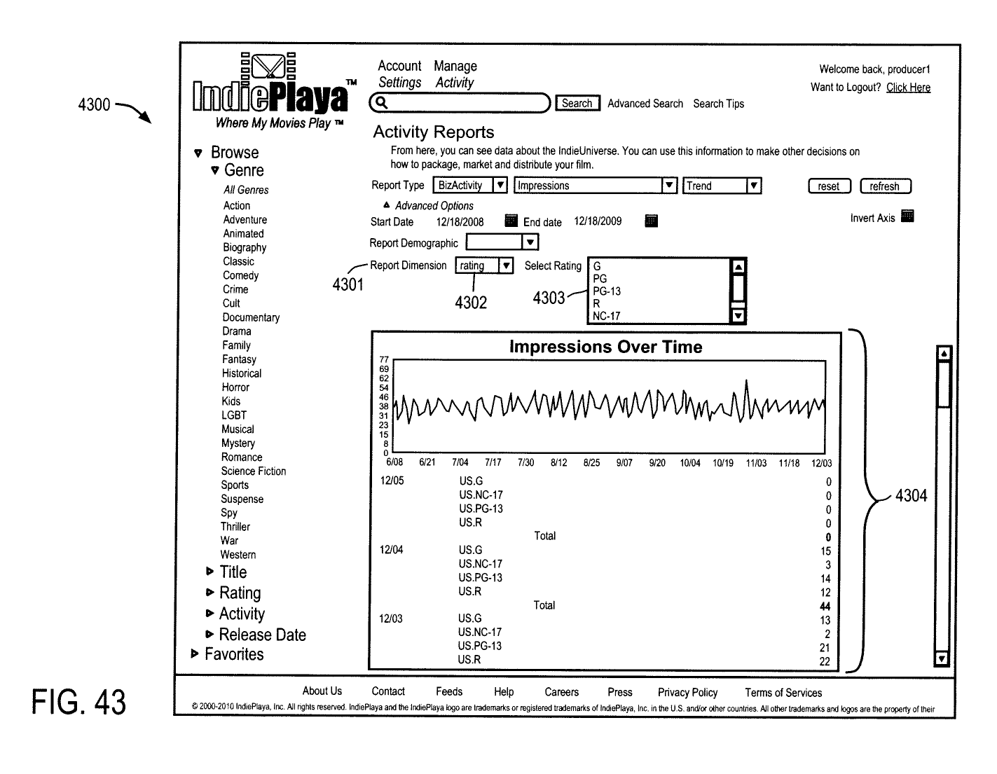

FIG. 43 shows an exemplary interface 4300 including another exemplary activity report. In this example, the activity report has been generated based upon the report dimension 4301. Report dimension 4301 can include a selectable region 4302 that can list one or more selectable report dimension options such as rating, video, genre, or type of license package. In this example, an activity report has been generated based upon a selection 4302 of report dimension 4301 rating. Additionally, a selection 4302 of a report dimension 4301 rating can cause the system to generate one or more additional options (e.g., dropdown menu 4303), for specifying content selection by rating. Exemplary interface 4300 also includes a graphic interpretation 4304 of the selected content.

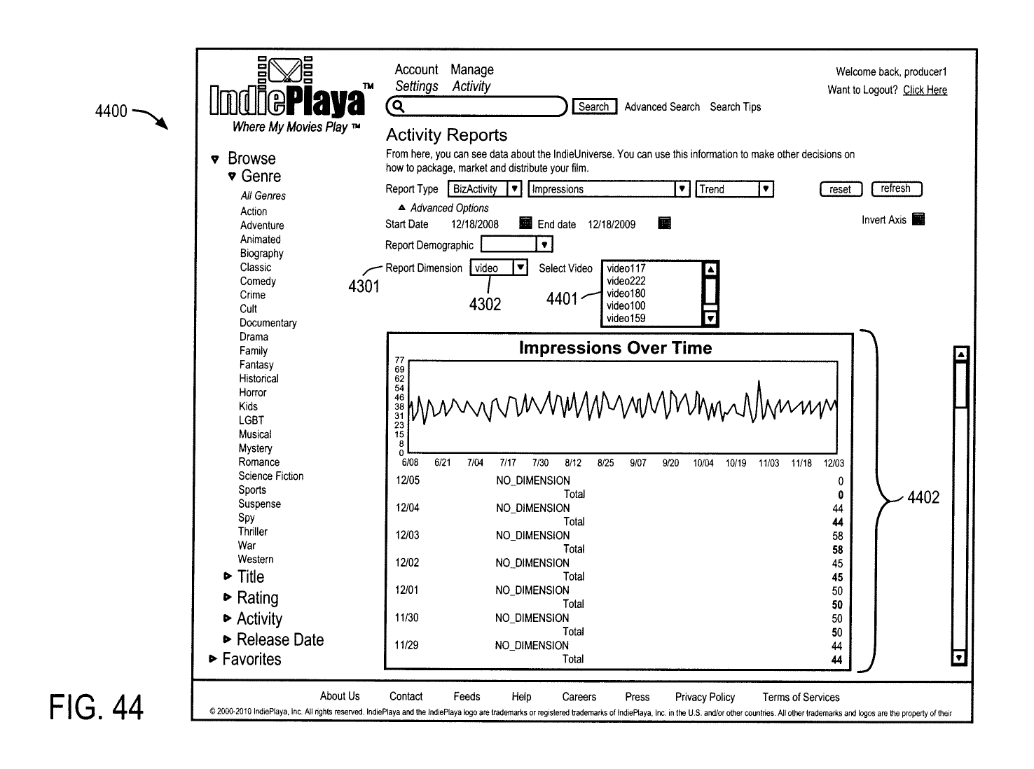

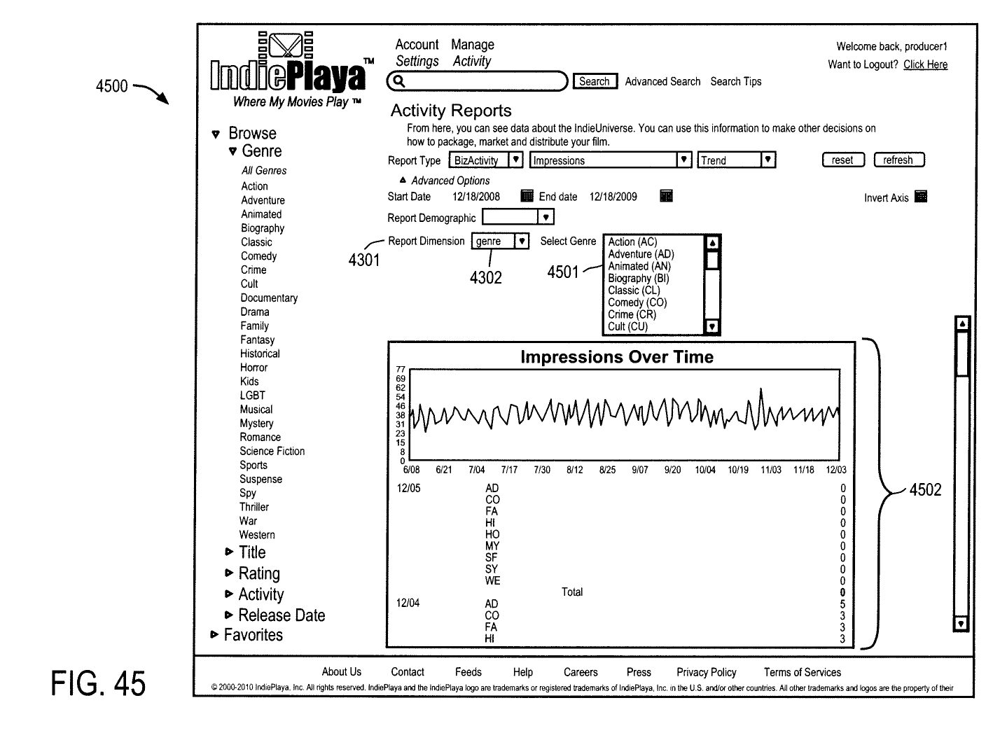

FIG. 44 shows an exemplary interface 4400 including another exemplary activity report. In this example, an activity report has been generated based upon a selection 4302 of the report dimension 4301 video. Additionally, a selection 4302 of a report dimension can cause the system to generate one or more additional options (e.g., dropdown menu 4401), for specifying content selection by video. Exemplary interface 4400 also includes a graphic interpretation 4402 of the selected content. FIG. 45 shows an exemplary interface 4500 including another example activity report. In this example, an activity report has been generated based upon a selection 4302 of report dimension 4301 genre. Additionally, a selection 4302 of the report dimension 4301 can cause the system to generate one or more additional options (e.g., dropdown menu 4501), for specifying content selection by genre. Exemplary interface 4500 also includes a graphic interpretation 4502 of the selected content.

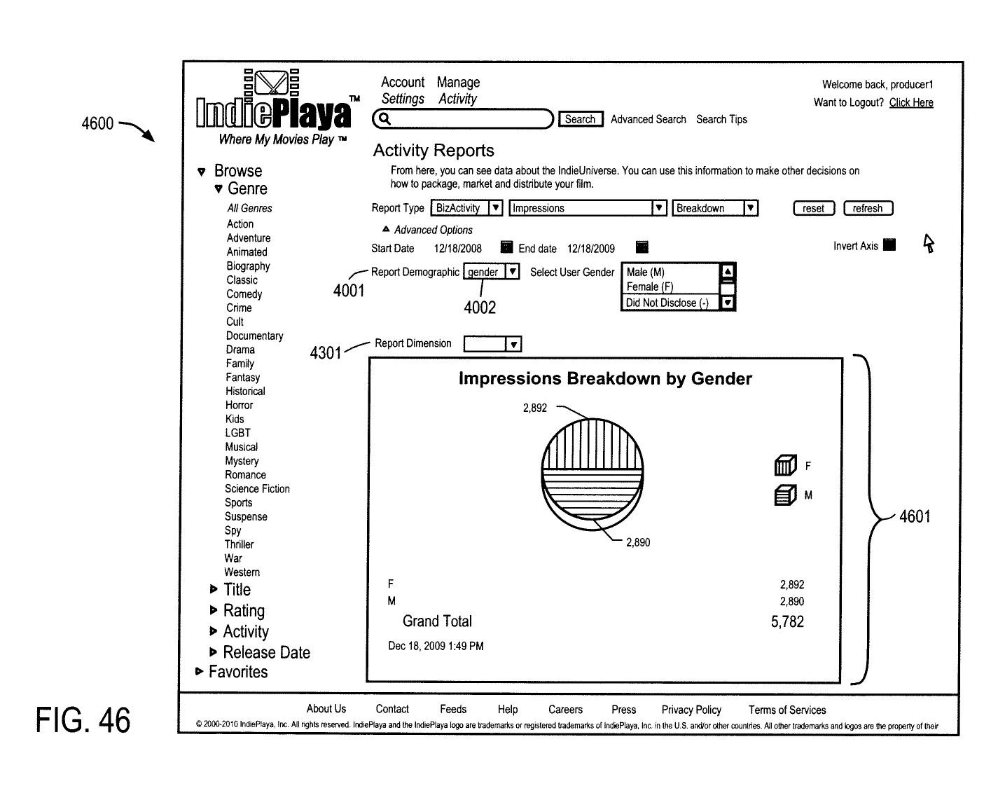

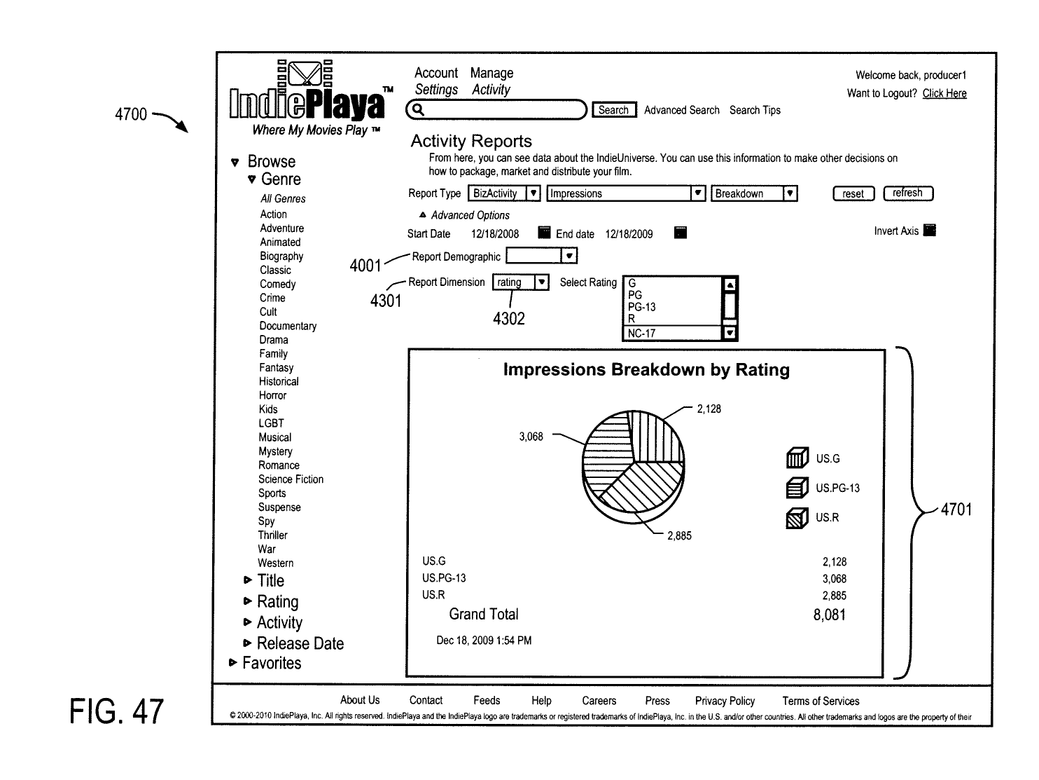

FIG. 46 shows an exemplary interface 4400 including a pie chart graphic interpretation 4601 of content. In this example, the content is graphically displayed in a pie chart 4601 in accordance with a selected 4002 report demographic 4001 gender. FIG. 47 shows an exemplary interface 4700 including a pie chart graphic interpretation 4701 of content. In this example, the content is graphically displayed in a pie chart 4701 in accordance with a selected 4302 report dimension 4301 rating. In some implementations, one or more reports can be generated based upon any combination of report demographic and report dimension selections.

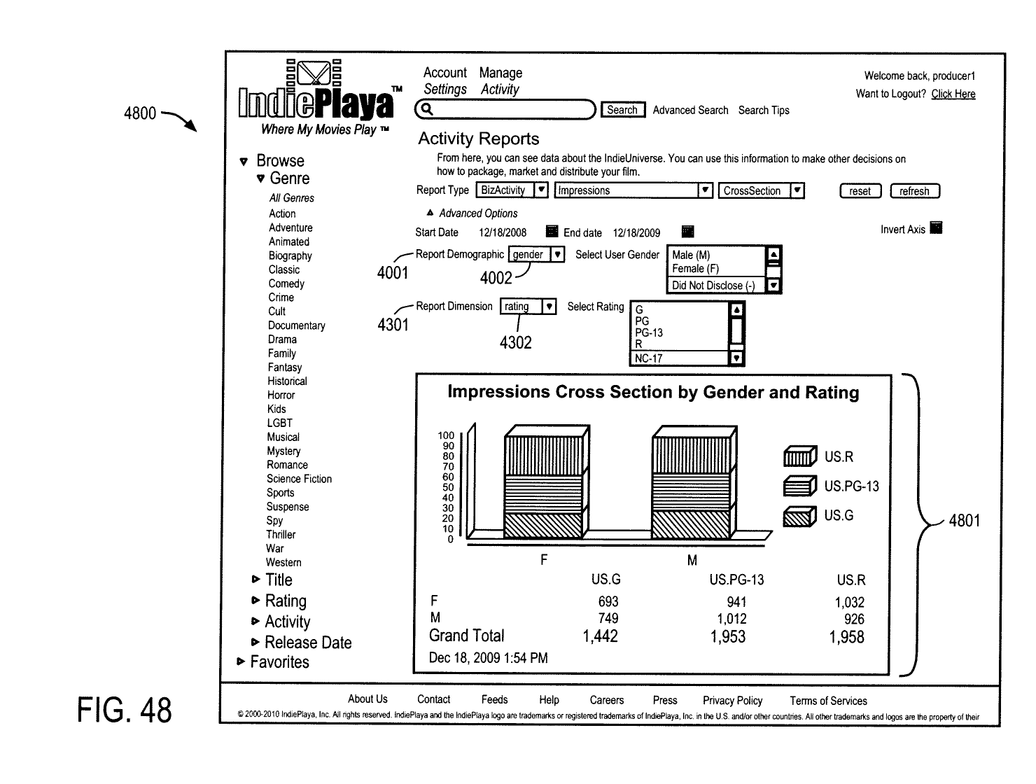

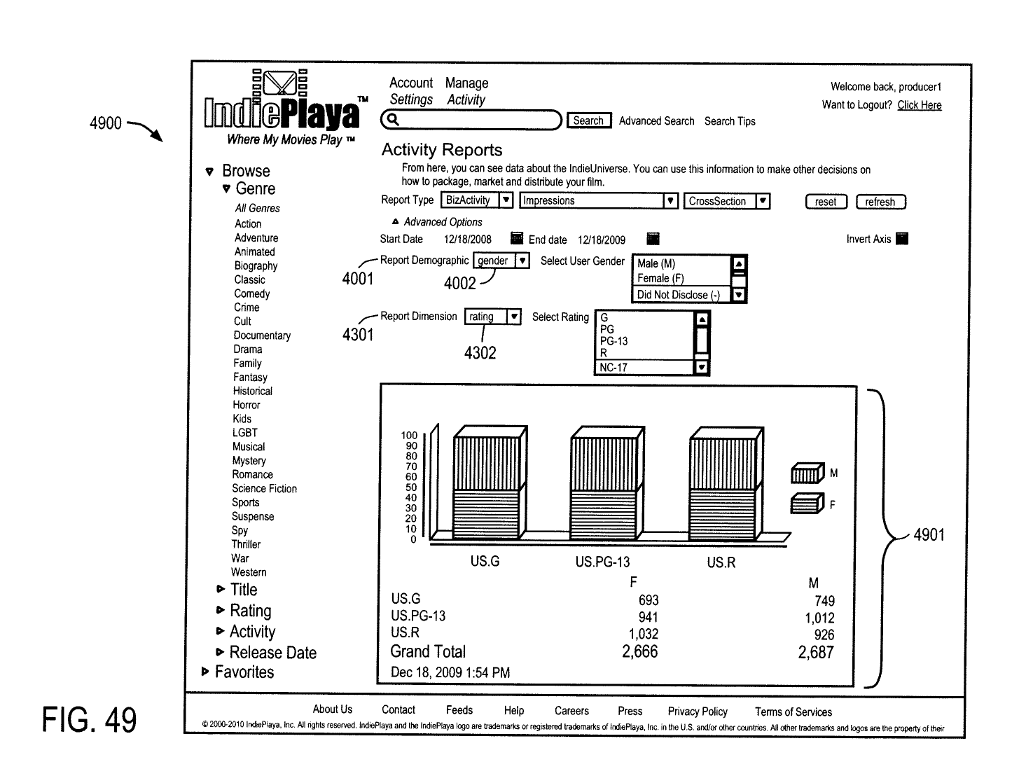

FIG. 48 shows an exemplary interface 4800 including a bar chart graphic interpretation 4801 of content. In this example, the content is graphically displayed in a bar chart 4801 in accordance with a selected 4002 report demographic 4001 gender and a selected 4302 report dimension 4301 rating (e.g., as a cross section graphic display by gender and rating). FIG. 49 shows an exemplary interface 4900 including a bar chart graphic interpretation 4901 of content. In this example, the content is graphically displayed in a bar chart 4901 in accordance with a selected 4002 report demographic 4001 gender and a selected 4302 report dimension 4301 rating (e.g., as a cross section graphic display by rating and gender).

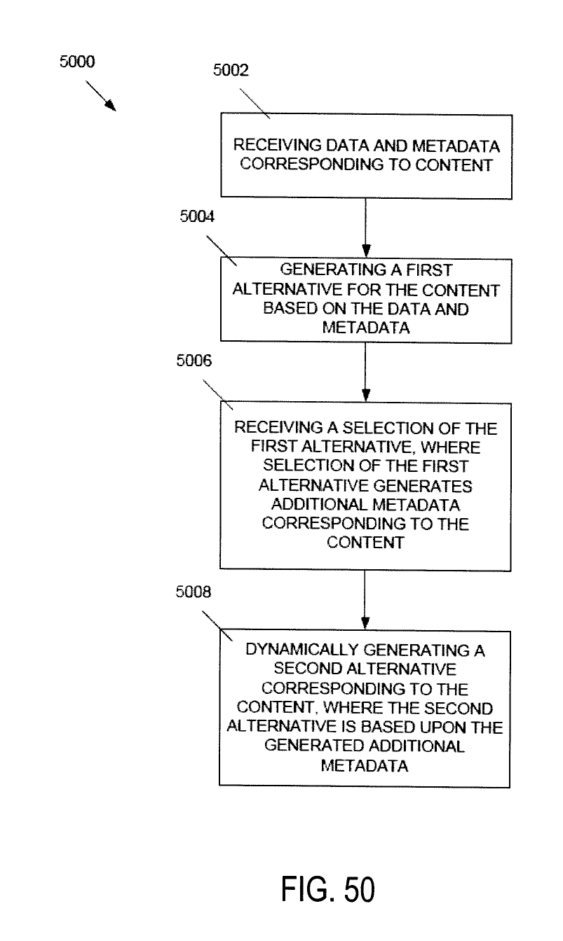

FIG. 50 is a flow diagram depicting an exemplary method for empowering content creators to market their own content without entering into onerous one-sided agreements with content promoters and marketers. Data and metadata corresponding to content are received at 5002, and a first alternative for the content is generated at 5004, where the first alternative is based on the data and metadata. For example, the content, the metadata, and the first alternative may be received using one or more networks by one or more servers and may be stored in one or more computer-readable data stores. At 5004, a selection of the first alternative is received, where the selection of the first alternative generates additional metadata corresponding to the content. At 5008, a second alternative corresponding to the content is dynamically generated, where the second alternative is based upon the generated additional metadata.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer-readable medium for execution by, or to control the operation of, data processing apparatus.

The computer-readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them, A propagated signal is an artificially generated signal, e.g., a machine-generated electrical, optical, or electromagnetic signal, that is generated to encode information for transmission to suitable receiver apparatus.

A computer program (also known as a program, software, software application, script, or code), can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., on or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit). The processes and logic flows can also be performed by one or more programmed computers that are individually or collectively suitably programmed to the processes and logic flows enumerated herein.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of nonvolatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) to LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any from, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed o a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Any of the methods of the present disclosure can be implemented in one or more computers or computer systems. Further still, any of the methods of the present disclosure can be implemented in one or more computer program products. Further still, any of the methods of the present disclosure can be implemented in one or more apparatus.

Thus, particular embodiments of the invention have been described. Other embodiments are within the scope of the following claims. For example, the actions recited in the claims can be performed in a different order and still achieve desirable results.

What is claimed is:

1. A method, comprising:
receiving, using one or more processors, (i) data or metadata for first content, or (ii) data or metadata related to the first content;
generating a first alternative for the first content, wherein the first alternative is based upon (i) data or metadata for the first content, or (ii) data or metadata related to the first content, and first aggregated content or content-related data or metadata associated with multiple content providers; and
receiving a selection of the first alternative, wherein the selection of the first alternative generates (i) first additional data or metadata for the first content, or (ii) first additional data or metadata for content related to the first content.

2. The method of claim 1, further comprising:
generating second aggregated content or content-related data or metadata from the (i) first additional data or metadata for the first content, or (ii) first additional data or metadata for content related to the first content; and
informing multiple content providers that the second aggregated content or content-related data or metadata has been generated.

3. The method of claim 1, wherein the (i) data or metadata for the first content, or (ii) data or metadata related to the first content includes one or more content attributes, and wherein each attribute is individually weighted.

4. The method of claim 3, wherein the one or more content attributes comprises one or more of a genre, a country of origin, a spoken language, a subtitle, a release date, a professional or government certification or rating, a selection by one or more industry festivals or events, a nomination or grant of one or more awards, or a list of participants in the first content.

5. The method of claim 3, wherein the one or more content attributes comprises a grouping or subgrouping of a plurality of user interactions with the first content, as measured against a plurality of user interactions with second media content different than the first content.

6. The method of claim 1, wherein the (i) first additional data or metadata for the first content, or (ii) first additional data or metadata for content related to the first content further includes data and metadata corresponding to one or more attributes of the first alternative.

7. The method of claim 6, wherein the data or metadata corresponding to the attributes of the first alternative comprises one or more of the terms, validity or access rights of the first alternative.

8. The method of claim 1, wherein (i) first additional data or metadata for the first content, or (ii) first additional data or metadata for content related to the first content further includes data or metadata corresponding to the context of the selection of the first alternative.

9. The method of claim 8, wherein the data or metadata corresponding to the context of the selection of the first alternative comprises a demographic of a user performing the selection.

10. The method of claim 8, wherein the data or metadata corresponding to the context of the selection of the first alternative comprises a grouping or subgrouping of a plurality of users performing a selection of the first alternative based on the history of a plurality of selections of the first alternative as measured against a plurality of selections of alternatives other than the first alternative.

11. The method of claim 2, wherein the informing further comprises:
processing the second aggregated content or content-related data or metadata to generate statistics; and
generating one or more reports using any combination of:
(A) the generated statistics,
(B) the (i) first additional data or metadata for the first content, or (ii) first additional data or metadata for content related to the first content, and
(C) the (i) second additional data or metadata for the first content, or (ii) second additional data or metadata for content related to the first content; and
displaying the one or more reports to multiple content creators.

12. The method of claim 11, wherein (A) the generated statistics, (B) the (i) first additional data or metadata for the first content, or (ii) first additional data or metadata for content related to the first content, or (C) the (i) second additional data or metadata for the first content, or (ii) second additional data or metadata for content related to the first content includes:
one or more of characteristics specific to the selector, characteristics specific to the content, or characteristics specific to the selection.

13. The method of claim 11, further comprising:
comparing the generated statistics to a predetermined threshold.

14. The method of claim 2, wherein a second alternative corresponding to the content is dynamically generated.

15. The method of claim 14, wherein the first alternative is an offer to use the first content for a predetermined amount of time, and wherein the second alternative is an offer to use the first content for a predetermined amount of time that is different from the predetermined amount of time corresponding to the first alternative.

16. The method of claim 14, wherein the first alternative is associated with a first type of content, and wherein the second alternative is associated with a second type of content that is different than, but related to, the first type of content.

17. The method of claim 14, wherein the first alternative is in one format and the second alternative is in a second format that is different from the first format.

18. The method of claim 14, wherein dynamically generating a second alternative further comprises:
receiving instructions to construct a second alternative in real-time;
constructing the second alternative in real-time; and
displaying the second alternative.

19. A computer-implemented system, comprising:
a data processor;
a computer-implemented memory encoded with instructions for commanding the data processor to perform steps that include:
receiving, using one or more processors, (i) data or metadata for first content, or (ii) data or metadata related to the first content;
generating a first alternative for the first content, wherein the first alternative is based upon (i) data or metadata for the first content, or (ii) data or metadata related to the first content, and first aggregated content or content-related data or metadata associated with multiple content providers; and
receiving a selection of the first alternative, wherein the selection of the first alternative generates (i) first additional data or metadata for the first content, or (ii) first additional data or metadata for content related to the first content.

20. The system of claim 19, wherein the steps further include:
generating second aggregated content or content-related data or metadata from the (i) first additional data or metadata for the first content, or (ii) first additional data or metadata for content related to the first content; and
informing multiple content providers that the second aggregated content or content-related data or metadata has been generated.

21. The system of claim 19, wherein the (i) data or metadata for the first content, or (ii) data or metadata related to the first content includes one or more content attributes, and wherein each attribute is individually weighted.

22. The system of claim 21, wherein the one or more content attributes comprises one or more of a genre, a country of origin, a spoken language, a subtitle, a release date, a professional or government certification or rating, a selection by one or more industry festivals or events, a nomination or grant of one or more awards, or a list of participants in the first content.

23. The system of claim 21, wherein the one or more content attributes comprises a grouping or subgrouping of a plurality of user interactions with the first content, as measured against a plurality of user interactions with second media content different than the first content.

24. The system of claim 19, wherein the (i) first additional data or metadata for the first content, or (ii) first additional data or metadata for content related to the first content further includes data and metadata corresponding to one or more attributes of the first alternative.

25. The system of claim 24, wherein the data or metadata corresponding to the attributes of the first alternative comprises one or more of the terms, validity or access rights of the first alternative.

26. The system of claim 19, wherein (i) first additional data or metadata for the first content, or (ii) first additional data or metadata for content related to the first content further includes data or metadata corresponding to the context of the selection of the first alternative.

27. The system of claim 26, wherein the data or metadata corresponding to the context of the selection of the first alternative comprises a demographic of a user performing the selection.

28. The system of claim 26, wherein the data or metadata corresponding to the context of the selection of the first alternative comprises a grouping or subgrouping of a plurality of users performing a selection of the first alternative based on the history of a plurality of selections of the first alternative as measured against a plurality of selections of alternatives other than the first alternative.

29. The system of claim 20, wherein the informing further comprises:
processing the second aggregated content or content-related data or metadata to generate statistics; and
generating one or more reports using any combination of:
(A) the generated statistics,
(B) the (i) first additional data or metadata for the first content, or (ii) first additional data or metadata for content related to the first content, and
(C) the (i) second additional data or metadata for the first content, or (ii) second additional data or metadata for content related to the first content; and
displaying the one or more reports to multiple content creators.

30. The system of claim 29, wherein (A) the generated statistics, (B) the (i) first additional data or metadata for the first content, or (ii) first additional data or metadata for content related to the first content, or (C) the (i) second additional data or metadata for the first content, or (ii) second additional data or metadata for content related to the first content includes:
one or more of characteristics specific to the selector, characteristics specific to the content, or characteristics specific to the selection.

31. The system of claim 29, wherein the steps further include:
comparing the generated statistics to a predetermined threshold.

32. The system of claim 20, wherein a second alternative corresponding to the content is dynamically generated.

33. The system of claim 32, wherein the first alternative is an offer to use the first content for a predetermined amount of time, and wherein the second alternative is an offer to use the first content for a predetermined amount of time that is different from the predetermined amount of time corresponding to the first alternative.

34. The system of claim 32, wherein the first alternative is associated with a first type of content, and wherein the second alternative is associated with a second type of content that is different than, but related to, the first type of content.

35. The system of claim 32, wherein the first alternative is in one format and the second alternative is in a second format that is different from the first format.

36. The system of claim 32, wherein dynamically generating a second alternative further comprises:
receiving instructions to construct a second alternative in real-time;
constructing the second alternative in real-time; and
displaying the second alternative.
